(19) United States
(12) Patent Application Publication
(10) Pub. No.: US 2024/0059911 A1
(43) Pub. Date: Feb. 22, 2024

(54) THERMALLY CONDUCTIVE AND ELECTRICALLY INSULATING AND/OR FIRE-RETARDANT ELECTRODEPOSITABLE COATING COMPOSITIONS

(71) Applicant: PPG Industries Ohio, Inc., Cleveland, OH (US)

(72) Inventors: Corey James Dedomenic, Trafford, PA (US); Liang Ma, Allison Park, PA (US); Marvin Michael Pollum, JR., Pittsburgh, PA (US); Egle Puodziukynaite, Allison Park, PA (US); Christopher Andrew Dacko, Pittsburgh, PA (US); Kevin Thomas Sylvester, Pittsburgh, PA (US); Steven Randolph Zawacky, Cranberry Township, PA (US)

(73) Assignee: PPG Industries Ohio, Inc., Cleveland, OH (US)

(21) Appl. No.: 18/257,811

(22) PCT Filed: Dec. 17, 2021
(86) PCT No.: PCT/US2021/064015

§ 371 Date: Jun. 15, 2023

Related U.S. Application Data
(60) Provisional application No. 63/127,392, filed on Dec. 18, 2020.

(51) Int. Cl. C09D 5/44; C09D 5/18; C09D 7/45; C09D 7/61; C09K 5/14; H01M 10/653; H01M 50/383

(52) U.S. Cl. CPC C09D 5/4457; C09D 5/4438; C09D 5/4465; C09D 5/18; C09D 7/45; C09D 7/61; C09K 5/14; H01M 10/653; H01M 50/383

(57) ABSTRACT

The present invention is directed towards an electrodepositable coating composition comprising an electrodepositable binder; and a thermally conductive, electrically insulative filler, a fire-retardant pigment, or a combination thereof. Also disclosed are methods of making the electrodepositable coating composition, coatings, and coated substrates.

### FIELD OF THE INVENTION

The present invention is directed towards an electrodepositable coating composition, coatings derived therefrom, and methods of applying such coatings.

### BACKGROUND INFORMATION

Substrates, such metal electrical components and batteries, are often protected with a high dielectric strength material to provide insulating properties. For example, components have been coated with a dielectric tapes and coatings to provide insulating properties. While dielectric tapes and coatings can provide insulating properties, they can be difficult to apply uniformly to substrates. In addition, it can be difficult to obtain good insulating properties at low coating film thicknesses. In addition, battery components can produce heat during use, and insulating tapes and coatings often have difficulty dissipating such heat by conducting it away from the underlying substrate.

Electrodeposition as a coating application method involves deposition of a film-forming composition onto a conductive substrate under the influence of an applied electrical potential. Electrodeposition has become standard in the coatings industry because, by comparison with non-electrophoretic coating means, electrodeposition offers increased paint utilization with less waste, improved corrosion protection to the substrate, and minimal environmental contamination.

There remains a need in the coatings industry for thermally conductive and electrically insulative coating that applies uniformly to substrates including at low film-thicknesses.

### SUMMARY OF THE INVENTION

Disclosed herein is a an electrodepositable coating composition comprising, consisting essentially of, or consisting of an electrodepositable binder; and a thermally conductive, electrically insulative filler material, a fire-retardant pigment, or a combination thereof.

The present invention further discloses a method for coating a substrate comprising electrodepositing a coating derived from the electrodepositable coating composition of the present invention onto at least a portion of the substrate.

The present invention also discloses a coating comprising an at least partially cured electrodepositable binder and a thermally conductive, electrically insulative filler material, a fire-retardant pigment, or a combination thereof.

The present invention also discloses a substrate that is coated, at least in part, with a coating comprising an at least partially cured electrodepositable binder and a thermally conductive, electrically insulative filler material, a fire-retardant pigment, or a combination thereof.

### DETAILED DESCRIPTION OF THE INVENTION

The present invention is directed to an electrodepositable coating composition comprising, consisting essentially of, or consisting of an electrodepositable binder; and a thermally conductive, electrically insulative filler material or a fire-retardant pigment.

As used herein, the term “electrodepositable coating composition” refers to a composition that is capable of being deposited onto an electrically conductive substrate under the influence of an applied electrical potential. The electrodepositable coating composition of the present invention may comprise a cationic electrodepositable coating composition or an anionic electrodepositable coating composition.

As used herein, the term “cationic electrodepositable coating composition” refers to an electrodepositable coating composition capable of being deposited onto an electrically conductive substrate by a cationic electrodeposition process, wherein a coating is deposited from the cationic electrodepositable coating composition deposits on the conductive substrate serving as the cathode during the electrodeposition process. A cationic electrodepositable coating composition comprises a cationic electrodepositable binder.

As used herein, the term “anionic electrodepositable coating composition” refers to an electrodepositable coating composition capable of being deposited onto an electrically conductive substrate by an anionic electrodeposition process, wherein a coating is deposited from the anionic electrodepositable coating composition deposits on the conductive substrate serving as the anode during the electrodeposition process. An anionic electrodepositable coating composition comprises an anionic electrodepositable binder.

Electrodepositable Binder

According to the present invention, the electrodepositable coating composition comprises an electrodepositable binder. The electrodepositable binder comprises an ionic salt group-containing film-forming polymer and may optionally further comprise a curing agent.

The ionic salt group-containing film-forming polymer may comprise functional groups. The functional groups of the ionic salt group-containing film-forming polymer may comprise active hydrogen functional groups. The term “active hydrogen” refers to hydrogens which, because of their position in the molecule, display activity according to the Zerewitinoff test, as described in the JOURNAL OF THE AMERICAN CHEMICAL SOCIETY, Vol. 49, page 3181 (1927). Accordingly, active hydrogens include hydrogen atoms attached to oxygen, nitrogen, or sulfur, and thus useful compounds will include those hydroxyl, thiol, primary amino, and/or secondary amino groups (in any combination). Ionic salt group-containing film-forming polymers that comprise active hydrogen functional groups may be referred to as active hydrogen-containing, ionic salt group-containing film-forming polymers. Other non-limiting examples of functional groups include epoxide functional groups, amide functional groups, carbamate functional groups, carboxylic acid groups, phosphorous acid groups (such as phosphoric acid and phosphonic acid), and sulfonic acid groups. The ionic salt group-containing film-forming polymer may comprise two or more functional groups, such as three or more functional groups per molecule.

According to the present invention, the electrodepositable binder may comprise a cationic electrodepositable binder that comprises a cationic salt group containing film-forming polymer.

As used herein, the term “cationic electrodepositable binder” refers to an organic resinous binder that includes cationic salt groups or cationic salt forming groups (that may be at least partially neutralized to form cationic salt groups) that impart a positive charge to polymeric components of the binder and that enable the binder to be deposited onto a conductive substrate by a cationic electrodeposition process.

As stated above, the cationic electrodepositable binder comprises a cationic salt group-containing film-forming polymer. As used herein, the term “cationic salt group-containing film-forming polymer” refers to polymers that include at least partially neutralized cationic salt groups that impart a positive charge, such as, for example, sulfonium groups, ammonium groups, or phosphonium groups. The cationic salt group containing film-forming polymer may be used in a cationic electrodepositable coating composition.

Examples of polymers that are suitable for use as the cationic salt group-containing film-forming polymer in the present invention include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present invention. Examples of these resins are those which are formed from reacting an organic polyepoxide with a tertiary amine acid salt. Such resins are described in U.S. Pat. No. 3,962,165 at col. 2, line 3 to col. 11, line 7; 3,975,346 at col. 1, line 62 to col. 17, line 25 and 4,001,156 at col. 1, line 37 to col. 16, line 7, these portions of which being incorporated herein by reference.

Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Patent Application No. 12463B1 at pg. 2, line 1 to pg. 6, line 25, this portion of which being incorporated herein by reference, may also be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Patent Application Publication No. 2003/0054193 A1 at paragraphs to [0088], this portion of which being incorporated herein by reference. Also suitable are the active hydrogen-containing, cationic salt group-containing resins derived from a polyglycidyl ether of a polyhydric phenol which are bonded more than one aromatic group, which are described in U.S. Patent Application Publication No. 2003/0054193 A1 at paragraphs to [0123], this portion of which being incorporated herein by reference. Also suitable are polypropylene oxide diepeoxide resins, such as DER-732 commercially available from Palmer Holland.

The active hydrogen-containing, cationic salt group-containing film-forming polymer is made cationic and water dispersible by at least partial neutralization with a neutralizing acid. Suitable neutralizing acids include organic and inorganic acids. Non-limiting examples of suitable organic neutralizing acids include formic acid, acetic acid, methanesulfonic acid, and lactic acid. Non-limiting examples of suitable inorganic neutralizing acids include and sulfamic acid. By “sulfamic acid” is meant sulfamic acid itself or derivatives thereof such as those having the formula:

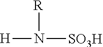

wherein R is hydrogen or an alkyl group having 1 to 4 carbon atoms. Mixtures of the above-mentioned acids also may be used in the present invention.

The extent of neutralization of the cationic salt group-containing film-forming polymer may vary with the particular polymer involved. However, sufficient neutralizing acid should be used to sufficiently neutralize the cationic salt group-containing film-forming polymer such that the cationic salt group-containing film-forming polymer may be dispersed in an aqueous dispersing medium. For example, the amount of neutralizing acid used may provide at least 20% of all of the total theoretical neutralization. Excess neutralizing acid may also be used beyond the amount required for 100% total theoretical neutralization. For example, the amount of neutralizing acid used to neutralize the cationic salt group-containing film-forming polymer may be ≥0.1% based on the total amines in the active hydrogen-containing, cationic salt group-containing film-forming polymer. Alternatively, the amount of neutralizing acid used to neutralize the active hydrogen-containing, cationic salt group-containing film-forming polymer may be ≤100% based on the total amines in the active hydrogen-containing, cationic salt group-containing film-forming polymer. The total amount of neutralizing acid used to neutralize the cationic salt group-containing film-forming polymer may range between any combination of values, which were recited in the preceding sentences, inclusive of the recited values. For example, the total amount of neutralizing acid used to neutralize the active hydrogen-containing, cationic salt group-containing film-forming polymer may be 20%, 35%, 50%, 60%, or 80% based on the total amines in the cationic salt group-containing film-forming polymer. Other acidic additives may be incorporated into the electrodepositable compositions leading to an increase in the total theoretical neutralization relative to just amount added with the neutralizing acid. When these acidic additives are present in the composition, the total theoretical neutralization (% TN) may be 60% to 250% TN, such as 65% to 200% TN, such as 70% to 175% TN, such as 75% to 150% TN.

According to the present invention, the cationic salt group-containing film-forming polymer may be present in the cationic electrodepositable coating composition in an amount of at least 40% by weight, such as at least 50% by weight, such as at least 60% by weight, such as at least 64% by weight, such as at least 66% by weight and may be present in the in an amount of no more than 90% by weight, such as no more than 80% by weight, such as no more than 77% by weight, such as no more than 74% by weight, such as no more than 72% by weight based on the total weight of the resin solids of the cationic electrodepositable coating composition. The cationic salt group-containing film-forming polymer may be present in the cationic electrodepositable coating composition in an amount of 40% to 90% by weight, such as 50% to 80% by weight, such as 60% to 77% by weight, such as 64% to 74% by weight, such as 66% to 72% by weight, based on the total weight of the resin solids of the cationic electrodepositable coating composition.

According to the present invention, the electrodepositable binder may comprise an anionic electrodepositable binder that comprises an anionic salt group containing film-forming polymer.

As used herein, the term “anionic salt group containing film-forming polymer” refers to an anionic polymer comprising at least partially neutralized anionic functional salt forming groups that impart a negative charge, such as, for example, carboxylic acid and phosphoric acid groups. The anionic salt group containing film-forming polymer may be used in an anionic electrodepositable coating composition.

The anionic salt group-containing film-forming polymer may comprise functional groups. The functional groups of the anionic salt group-containing film-forming polymer may comprise active hydrogen functional groups. Anionic salt group-containing film-forming polymers that comprise active hydrogen functional groups may be referred to as active hydrogen-containing, anionic salt group-containing film-forming polymers.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Pat. Application Publication No. 2009-0045071 at [0004]-[0015] and U.S. patent application Ser. No. 13/232,093 at [0014]-[0040], the cited portions of which being incorporated herein by reference. Also suitable are resins comprising one or more pendent carbamate functional groups, such as those described in U.S. Pat. No. 6,165,338.

According to the present invention, the anionic salt group-containing film-forming polymer may be present in the anionic electrodepositable coating composition in an amount of at least 50% by weight, such as at least 55% by weight, such as at least 60% by weight, and may be present in an amount of no more than 90% by weight, such as no more than 80% by weight, such as no more than 75% by weight, based on the total weight of the resin solids of the electrodepositable coating composition. The anionic salt group-containing film-forming polymer may be present in the anionic electrodepositable coating composition in an amount 50% to 90%, such as 55% to 80%, such as 60% to 75%, based on the total weight of the resin solids of the electrodepositable coating composition.

According to the present invention, the electrodepositable binder of the electrodepositable coating composition of the present invention may optionally further comprise a curing agent. The curing agent comprises functional groups reactive with functional groups on the film-forming polymer. For example, the functional groups of the curing agent may react with the reactive groups, such as active hydrogen groups, of the ionic salt group-containing film-forming polymer to effectuate cure of the coating composition to form a coating. As used herein, the term “cure”, “cured” or similar terms, as used in connection with the electrodepositable coating compositions described herein, means that at least a portion of the components that comprise the electrodepositable coating composition are crosslinked to form a coating. Additionally, curing of the electrodepositable coating composition refers to subjecting said composition to curing conditions (e.g., elevated temperature) leading to the reaction of the reactive functional groups of the components of the electrodepositable coating composition, and resulting in the crosslinking of the components of the composition and formation of an at least partially cured coating. Non-limiting examples of suitable curing agents are at least partially blocked polyisocyanates, aminoplast resins and phenoplast resins, such as phenolformaldehyde condensates including allyl ether derivatives thereof.

Suitable at least partially blocked polyisocyanates include aliphatic polyisocyanates, aromatic polyisocyanates, and mixtures thereof. The curing agent may comprise an at least partially blocked aliphatic polyisocyanate. Suitable at least partially blocked aliphatic polyisocyanates include, for example, fully blocked aliphatic polyisocyanates, such as those described in U.S. Pat. No. 3,984,299 at col. 1 line 57 to col. 3 line 15, this portion of which is incorporated herein by reference, or partially blocked aliphatic polyisocyanates that are reacted with the polymer backbone, such as is described in U.S. Pat. No. 3,947,338 at col. 2 line 65 to col. 4 line 30, this portion of which is also incorporated herein by reference. By “blocked” is meant that the isocyanate groups have been reacted with a compound such that the resultant blocked isocyanate group is stable to active hydrogens at ambient temperature but reactive with active hydrogens in the film forming polymer at elevated temperatures, such as between 90° C. and 200° C. The polyisocyanate curing agent may be a fully blocked polyisocyanate with substantially no free isocyanate groups.

The polyisocyanate curing agent may comprise a diisocyanate, higher functional polyisocyanates or combinations thereof. For example, the polyisocyanate curing agent may comprise aliphatic and/or aromatic polyisocyanates. Aliphatic polyisocyanates may include (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexmethylene diisocyanate (also known as the isocyanurate trimer of HDI, commercially available as Desmodur N3300 from Convestro AG), and meta-tetramethylxylylene diisocyanate (commercially available as TMXDI® from Allnex SA). Aromatic polyisocyanates may include (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′,4″-triisocyanate, 1,3,5-triisocyanato benzene and 2,4,6-triisocyanato toluene, tetraisocyanates, such as 4,4′-diphenyldimethyl methane-2,2′,5,5′-tetraisocyanate, and polymerized polyisocyanates, such as tolylene diisocyanate dimers and trimers and the like, may also be used. The curing agent may comprise a blocked polyisocyanate selected from a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

The polyisocyanate curing agent may be at least partially blocked with at least one blocking agent selected from a 1,2-alkane diol, for example 1,2-propanediol; a 1,3-alkane diol, for example 1,3-butanediol; a benzylic alcohol, for example, benzyl alcohol; an allylic alcohol, for example, allyl alcohol; caprolactam; a dialkylamine, for example dibutylamine; and mixtures thereof. The polyisocyanate curing agent may be at least partially blocked with at least one 1,2-alkane diol having three or more carbon atoms, for example 1,2-butanediol.

Other suitable blocking agents include aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime.

For example, the blocking agent may comprise an ether or polyether comprising a hydroxyl group and a terminal group having the structure —O—R, wherein R is a C₁ to C₄ alkyl group, such as a C₁ to C₃ alkyl group, or two terminal hydroxyl groups. The polyether may comprise a homopolymer, block copolymer, or random copolymer. For example, the polyether may comprise a homopolymer of ethylene oxide or propylene oxide, or the polyether may comprise block or random copolymer comprising a combination of ethylene oxide and propylene oxide in a block or random pattern. Such blocking groups may comprise the structure:

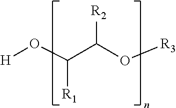

wherein R₁ and R₂ are each hydrogen or one of the R₁ and R₂ is hydrogen and the other is a methyl group; R₃ is H or a C₁ to C₄ alkyl group, such as a C₁ to C₃ alkyl group; and n is an integer from 1-50, such as from 1-40, such as from 1-30, such as from 1-20, such as from 1-12, such as from 1-8, such as from 1-6, such as from 1-4, such as from 2-50, such as from 2-40, such as from 2-30, such as from 2-20, such as from 2-12, such as from 2-8, such as from 2-6, such as from 2-4, such as from 3-50, such as from 3-40, such as from 3-30, such as from 3-20, such as from 3-12, such as from 3-8, such as from 3-6, such as from 3-4.

The curing agent may optionally comprise a high molecular weight volatile group. As used herein, the term “high molecular weight volatile group” refers to blocking agents and other organic byproducts that are produced and volatilized during the curing reaction of the electrodepositable coating composition having a molecular weight of at least 70 g/mol, such as at least 125 g/mol, such as at least 160 g/mol, such as at least 195 g/mol, such as at least 400 g/mol, such as at least 700 g/mol, such as at least 1000 g/mol, or higher, and may range from 70 to 1,000 g/mol, such as 160 to 1,000 g/mol, such as 195 to 1,000 g/mol, such as 400 to 1,000 g/mol, such as 700 to 1,000 g/mol. For example, the organic byproducts may include alcoholic byproducts resulting from the reaction of the film-forming polymer and an aminoplast or phenoplast curing agent, and the blocking agents may include organic compounds, including alcohols, used to block isocyanato groups of polyisocyanates that are unblocked during cure. For clarity, the high molecular weight volatile groups are covalently bound to the curing agent prior to cure, and explicitly exclude any organic solvents that may be present in the electrodepositable coating composition. Upon curing, the pigment-to-binder ratio of the deposited film may increase in the cured film relative to deposited uncured pigment-to-binder ratio in the electrodepositable coating composition because of the loss of a higher mass of the blocking agents and other organic byproducts derived from the curing agent that are volatilized during cure. High molecular weight volatile groups may comprise 5% to 50% by weight of the film-forming binder, such as 7% to 45% by weight, such as 9% to 40% by weight, such as 11% to 35%, such as 13% to 30%, based on the total weight of the electrodepositable binder. The high molecular weight volatile groups and other lower molecular weight volatile organic compounds produced during cure, such as lower molecular weight blocking agents and organic byproducts produced during cure, may be present in an amount such that the relative weight loss of the film-forming binder deposited onto the substrate relative to the weight of the film-forming binder after cure is an amount of 5% to 50% by weight of the film-forming binder, such as 7% to 45% by weight, such as 9% to 40% by weight, such as 11% to 35%, such as 13% to 30%, based on the total weight of the electrodepositable binder before and after cure.

The curing agent may comprise an aminoplast resin. Aminoplast resins are condensation products of an aldehyde with an amino- or amido-group carrying substance. Condensation products obtained from the reaction of alcohols and an aldehyde with melamine, urea or benzoguanamine may be used. However, condensation products of other amines and amides may also be employed, for example, aldehyde condensates of triazines, diazines, triazoles, guanidines, guanamines and alkyl- and aryl-substituted derivatives of such compounds, including alkyl- and aryl-substituted ureas and alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. Suitable aldehydes include formaldehyde, acetaldehyde, crotonaldehyde, acrolein, benzaldehyde, furfural, glyoxal and the like.

The aminoplast resins may contain methylol or similar alkylol groups, and at least a portion of these alkylol groups may be etherified by a reaction with an alcohol to provide organic solvent-soluble resins. Any monohydric alcohol may be employed for this purpose, including such alcohols as methanol, ethanol, propanol, butanol, pentanol, hexanol, heptanol and others, as well as benzyl alcohol and other aromatic alcohols, cyclic alcohol such as cyclohexanol, monoethers of glycols such as Cello solves and Carbitols, and halogen-substituted or other substituted alcohols, such as 3-chloropropanol and butoxyethanol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as the aldehyde agent. Various phenols may be used, such as phenol itself, a cresol, or a substituted phenol in which a hydrocarbon radical having either a straight chain, a branched chain or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol and unsaturated hydrocarbon-substituted phenols, such as the monobutenyl phenols containing a butenyl group in ortho, meta or para position, and where the double bond occurs in various positions in the hydrocarbon chain.

Aminoplast and phenoplast resins, as described above, are described in U.S. Pat. No. 4,812,215 at co1.6, line 20 to col. 7, line 12, the cited portion of which being incorporated herein by reference.

The curing agent may be present in the cationic electrodepositable coating composition in an amount of at least 10% by weight, such as at least 20% by weight, such as at least 25% by weight, and may be present in an amount of no more than 60% by weight, such as no more than 50% by weight, such as no more than 40% by weight, based on the total weight of the resin solids of the electrodepositable coating composition. The curing agent may be present in the cationic electrodepositable coating composition in an amount of 10% to 60% by weight, such as 20% to 50% by weight, such as 25% to 40% by weight, based on the total weight of the resin solids of the electrodepositable coating composition.

The curing agent may be present in the anionic electrodepositable coating composition in an amount of at least 10% by weight, such as at least 20% by weight, such as at least 25% by weight, and may be present in an amount of no more than 50% by weight, such as no more than 45% by weight, such as no more than 40% by weight, based on the total weight of the resin solids of the electrodepositable coating composition. The curing agent may be present in the anionic electrodepositable coating composition in an amount of 10% to 50% by weight, such as 20% to 45% by weight, such as 25% to 40% by weight, based on the total weight of the resin solids of the electrodepositable coating composition.

Thermally Conductive, Electrically Insulative Filler Material

According to the present invention, the electrodepositable coating composition further comprises a thermally conductive, electrically insulative filler material.

As used herein, the term “thermally conductive, electrically insulative filler” or “TC/EI filler” means a pigment, filler, or inorganic powder that has a thermal conductivity of at least 5 W/m·K at 25° C. (measured according to ASTM D7984) and a volume resistivity of at least 10 Ω·m (measured according to ASTM D257, C611, or B193). The TC/EI filler material may comprise organic or inorganic material and may comprise particles of a single type of filler material or may comprise particles of two or more types of TC/EI filler materials. That is, the TC/EI filler material may comprise particles of a first TC/EI filler material and may further comprise particles of at least a second (i.e., a second, a third, a fourth, etc.) TC/EI filler material that is different from the first TC/EI filler material. As used herein with respect to types of filler material, reference to “first,” “second”, etc. is for convenience only and does not refer to order of addition or the like.

The TC/EI filler material may have a thermal conductivity of at least 5 W/m·K at 25° C. (measured according to ASTM D7984), such as at least 18 W/m·K, such as at least 55 W/m·K. The TC/EI filler material may have a thermal conductivity of no more than 3,000 W/m·K at 25° C. (measured according to ASTM D7984), such as no more than 1,400 W/m·K, such as no more than 450 W/m·K. The TC/EI filler material may have a thermal conductivity of 5 W/m·K to 3,000 W/m·K at 25° C. (measured according to ASTM D7984), such as 18 W/m·K to 1,400 W/m·K, such as 55 W/m·K to 450 W/m·K.

The TC/EI filler material may have a volume resistivity of at least 10 Ω·m (measured according to ASTM D257, C611, or B193), such as at least 20 Ω·m, such as at least 30 Ω·m, such as at least 40 Ω·m, such as at least 50 Ω·m, such as at least 60 Ω·m, such as at least 60 Ω·m, such as at least 70 Ω·m, such as at least 80 Ω·m, such as at least 80 Ω·m, such as at least 90 Ω·m, such as at least 100 Ω·m.

Suitable non-limiting examples of TC/EI filler materials include nitrides, metal oxides, metalloid oxides, metal hydroxides, arsenides, carbides, minerals, ceramics, and diamond. For example, the TC/EI filler material may comprise, consist essentially of, or consist of boron nitride, silicon nitride, aluminum nitride, boron arsenide, aluminum oxide, magnesium oxide, dead burned magnesium oxide, beryllium oxide, silicon dioxide, titanium oxide, zinc oxide, nickel oxide, copper oxide, tin oxide, aluminum hydroxide, magnesium hydroxide, boron arsenide, silicon carbide, agate, emery, ceramic microspheres, diamond, or any combination thereof. Non-limiting examples of commercially available TC/EI filler materials of boron nitride include, for example, CarboTherm from Saint-Gobain, CoolFlow and PolarTherm from Momentive, and as hexagonal boron nitride powder available from Panadyne; of aluminum nitride, for example, aluminum nitride powder available from Micron Metals Inc., and as Toyalnite from Toyal; of aluminum oxide include, for example, Microgrit from Micro Abrasives, Nabalox from Nabaltec, Aeroxide from Evonik, and as Alodur from Imerys; of dead burned magnesium oxide include, for example, MagChem® P98 from Martin Marietta Magnesia Specialties; of aluminum hydroxide include, for example, APYRAL from Nabaltec GmbH and aluminum hydroxide from Sibelco; and of ceramic microspheres include, for example, ceramic microspheres from Zeeospheres Ceramics or 3M. These fillers can also be surface modified. For example, surface modified magnesium oxide available as PYROKISUMA 5301K available from Kyowa Chemical Industry Co., Ltd. Alternatively, the TC/EI filler materials may be free of any surface modification.

As used herein, the term “dead burned magnesium oxide” refers to magnesium oxide that has been calcined at high-temperatures (e.g., ranging from 1500° C.-2000° C. in a high temperature shaft kiln) yielding a material with very little reactivity relative to magnesium oxide that has not been calcined.

The TC/EI filler material may have any particle shape or geometry. For example, the TC/EI filler material may be a regular or irregular shape and may be spherical, ellipsoidal, cubical, platy, acicular (elongated or fibrous), rod-shaped, disk-shaped, prism-shaped, flake-shaped, irregular, rock-like, etc., agglomerates thereof, and any combination thereof.

Particles of TC/EI filler material may have a reported average particle size in at least one dimension of at least 0.01 microns, as reported by the manufacturer, such as at least 2 microns, such as at least 10 microns. Particles of TC/EI filler material may have a reported average particle size in at least one dimension of up to 100 microns or more, such as no more than 100 microns, such as no more than 50 microns, such as no more than 40 microns, such as no more than 25 microns. The particles of TC/EI filler material may have a reported average particle size in at least one dimension of 0.01 microns to 100 microns as reported by the manufacturer, such as 0.01 microns to 50 microns, such as 0.01 microns to 40 microns, such as 0.01 microns to 25 microns, such as 2 microns to 100 microns, such as 2 microns to 50 microns, such as 2 microns to 40 microns, such as 2 microns to 25 microns, such as 10 micron to 100 microns, such as 10 microns to 50 microns, such as 10 microns to 40 microns, such as 10 microns to 25 microns. Suitable methods of measuring average particle size include, for example, measurement using an instrument such as the Quanta 250 FEG SEM or an equivalent instrument.

Particles of TC/EI filler material of the electrodepositable coating composition may have a reported Mohs hardness of at least 1 (based on the Mohs Hardness Scale), such as at least 2, such as at least 3. Particles of TC/EI filler material of the electrodepositable coating composition may have a reported Mohs hardness of no more than 10, such as no more than 8, such as no more than 7. Particles of TC/EI filler material of the electrodepositable coating composition may have a reported Mohs hardness of 1 to 10, such as 2 to 8, such as 3 to 7.

The thermally conductive, electrically insulative filler material may be present in an amount of at least 1% by volume, such as at least 5% by volume, such as at least 25% by volume, such as at least 30% by volume, based on the total volume of the solids of the electrodepositable coating composition. The thermally conductive, electrically insulative filler material may be present in an amount of no more than 70% by volume, such as no more than 50% by volume, such as no more than 30% by volume, based on the total volume of the solids of the electrodepositable coating composition. The thermally conductive, electrically insulative filler material may be present in an amount of 1% to 70% by volume, such as 5% to 50% by volume, such as 25% to 50% by volume, such as 30% to 50% by volume, based on the total volume of the solids of the electrodepositable coating composition.

The electrodepositable coating composition may optionally further comprise particles of thermally conductive, electrically conductive filler material (referred to herein as “TC/EC” filler material) and/or particles of non-thermally conductive, electrically insulative filler material (referred to herein as “NTC/EI” filler material). The TC/EC filler material and/or the NTC/EI filler material may be organic or inorganic.

Alternatively, the electrodepositable coating composition could be substantially free, essentially free, or completely free of either or both of the TC/EC filler material and/or the NTC/EI filler material.

The TC/EC filler material and/or NTC/EI filler material may have any particle shape or geometry. For example, the TC/EC filler material and/or the NTC/EI filler material may be a regular or irregular shape and may be spherical, ellipsoidal, cubical, platy, acicular (elongated or fibrous), rod-shaped, disk-shaped, prism-shaped, flake-shaped, irregular, rock-like, etc., agglomerates thereof, and any combination thereof.

Particles of the TC/EC filler material and/or the NTC/EI filler material may have a reported average particle size in at least one dimension, such as, for example, the particle sizes provided for the thermally conductive, electrically insulative filler material, as described above.

Particles of TC/EC filler material and/or the NTC/EI filler material of the electrodepositable coating composition may have a reported Mohs hardness of at least 1 (based on the Mohs Hardness Scale), such as at least 2, such as at least 3. Particles of TC/EC filler material and/or the NTC/EI filler material of the electrodepositable coating composition may have a reported Mohs hardness of no more than 10, such as no more than 8, such as no more than 7. Particles of TC/EC filler material and/or the NTC/EI filler material of the electrodepositable coating composition may have a reported Mohs hardness of 1 to 10, such as 2 to 8, such as 3 to 7.

As used herein, the term “thermally conductive, electrically conductive filler” or “TC/EC filler” means a pigment, filler, or inorganic powder that has a thermal conductivity of at least 5 W/m·K at 25° C. (measured according to ASTM D7984) and a volume resistivity of less than 10 Ω·m (measured according to ASTM D257, C611, or B193). For example, the TC/EC filler material may have a thermal conductivity of at least 5 W/m·K at 25° C. (measured according to ASTM D7984), such as at least 18 W/m·K, such as at least 55 W/m·K. The TC/EC filler material may have a thermal conductivity of no more than 3,000 W/m·K at 25° C. (measured according to ASTM D7984), such as no more than 1,400 W/m·K, such as no more than 450 W/m·K. The TC/EC filler material may have a thermal conductivity of 5 W/m·K to 3,000 W/m·K at 25° C. (measured according to ASTM D7984), such as 18 W/m·K to 1,400 W/m·K, such as 55 W/m·K to 450 W/m·K. For example, the TC/EC filler material may have a volume resistivity of less than 10 Ω·m (measured according to ASTM D257, C611, or B193), such as less than 5 Ω·m, such as less than 1 Ω·m.

Suitable TC/EC filler materials include metals such as silver, zinc, copper, gold, carbon compounds such as graphite (such as Timrex commercially available from Imerys or ThermoCarb commercially available from Asbury Carbons), carbon black (for example, commercially available as Vulcan from Cabot Corporation), carbon fibers (for example, commercially available as milled carbon fiber from Zoltek), graphene and graphenic carbon particles (for example, xGnP graphene nanoplatelets commercially available from XG Sciences, and/or for example, the graphene particles described below), carbonyl iron, copper (such as spheroidal powder commercially available from Sigma Aldrich), zinc (such as Ultrapure commercially available from Purity Zinc Metals and Zinc Dust XL and XLP available from US Zinc), and the like.

Examples of “graphenic carbon particles” include carbon particles having structures comprising one or more layers of one-atom-thick planar sheets of sp2-bonded carbon atoms that are densely packed in a honeycomb crystal lattice. The average number of stacked layers may be less than 100, for example, less than 50. The average number of stacked layers may be 30 or less, such as 20 or less, such as 10 or less, such as 5 or less. The graphenic carbon particles may be substantially flat; however, at least a portion of the planar sheets may be substantially curved, curled, creased, or buckled. The particles typically do not have a spheroidal or equiaxed morphology. Suitable graphenic carbon particles are described in U.S. Publication No. 2012/0129980, at paragraphs [0059]-[0065], the cited portion of which is incorporated herein by reference. Other suitable graphenic carbon particles are described in U.S. Pat. No. 9,562,175, at 6:6 to 9:52, the cited portion of which are incorporated herein by reference.

As used herein, the term “non-thermally conductive, electrically insulative filler” or “NTC/EI filler” means a pigment, filler, or inorganic powder that that has a thermal conductivity of less than 5 W/m·K at 25° C. (measured according to ASTM D7984) and a volume resistivity of at least 10 Ω·m (measured according to ASTM D257, C611, or B193). For example, the NTC/EI filler may have a thermal conductivity of less than 5 W/m·K at 25° C. (measured according to ASTM D7984, such no more than 3 W/m·K, such as no more than 1 W/mK, such as no more than 0.1 W/mK, such as no more than 0.05 W/mK. For example, the NTC/EI filler may have a volume resistivity of at least 10 am (measured according to ASTM D257, C611, or B193), such as at least 20 Ω·m, such as at least 30 Ω·m, such as at least 40 Ω·m, such as at least 50 Ω·m, such as at least 60 Ω·m, such as at least 60 Ω·m, such as at least 70 Ω·m, such as at least 80 Ω·m, such as at least 80 Ω·m, such as at least 90 Ω·m, such as at least 100 Ω·m.

Suitable non-limiting examples of NTC/EI filler materials include but are not limited to silica, wallastonite, calcium carbonate, clay, or any combination thereof.

The silica (SiO₂) may comprise fumed silica which comprises silica that has been treated with a flame to form a three-dimensional structure. The fumed silica may be untreated or surface treated with a siloxane, such as, for example, polydimethylsiloxane. Exemplary non-limiting commercially available fumed silica includes products solder under the trade name AEROSIL®, such as AEROSIL® R 104, AEROSIL® R 106, AEROSIL® R 202, AEROSIL® R 208, AEROSIL® R 972 commercially available from Evonik Industries and products sold under the trade name HDK® such as HDK® H17 and HDK® H18 commercially available from Wacker Chemie AG.

Wollastonite comprises a calcium inosilicate mineral (CaSiO₃) that may contain small amounts of iron, aluminum, magnesium, manganese, titanium and/or potassium. For example, the wollastonite may have a B.E.T. surface area of 1.5 to 2.1 m²/g, such as 1.8 m²/g and a median particle size of 6 microns to 10 microns, such as 8 microns. Non-limiting examples of commercially available wollastonite include NYAD 400 available from NYCO Minerals, Inc.

The calcium carbonate (CaCO₃) may comprise a precipitated calcium carbonate or a ground calcium carbonate. The calcium carbonate may or may not be surface treated with stearic acid. Non-limiting examples of commercially available precipitated calcium carbonate include Ultra-Pflex®, Albafil®, and Albacar HO® available from Specialty Minerals and Winnofil® SPT available from Solvay. Non-limiting examples of commercially available ground calcium carbonate include Duramite™ available from IMERYS and Marblewhite® available from Specialty Minerals.

Useful clay minerals include a non-ionic platy filler such as talc, pyrophyllite, chlorite, vermiculite, or combinations thereof.

The electrodepositable coating composition may optionally comprise a dispersing agent to assist in dispersing the thermally conductive, electrically insulative filler material and other optional filler materials.

As used herein, the term “dispersing agent” refers to a material capable of improving the dispersion stability of the thermally conductive, electrically insulative filler material in the electrodepositable coating composition. For example, the dispersing agent may form a chemical complex with the thermally conductive, electrically insulative filler material that, and the complexed thermally conductive, electrically insulative filler material may resist settling better than when the dispersing agent is not present. A complex formed between the thermally conductive, electrically insulative filler material and the dispersing agent may be referred to as a thermally conductive, electrically insulative filler material-dispersing agent complex. As used herein, the term “complex” refers to a substance formed by the chemical interaction, such as ionic bonding, covalent bonding, and/or hydrogen bonding, between two distinct chemical species. These species will generally be part of a dispersion phase having one component or multiple components that is not soluble in the bulk media and other component(s) that are soluble in the bulk material.

The dispersing agent may comprise a dispersing acid. The dispersing acid may be a monoprotic acid or polyprotic acid. As used herein, the term “polyprotic acid” refers to chemical compounds having more than one acidic proton. As used herein, the term “acidic proton” refers to a proton that forms part of an acid group, including, but not limited to, oxyacids of phosphorus, carboxylic acids, oxyacids of sulfur, and the like.

The dispersing acid may comprise a first acidic proton having a pKa of at least 1.1, such as at least 1.5, such as at least 1.8. The dispersing acid may comprise a first acidic proton having a pKa of no more than 4.6, such as no more than 4.0, such as no more than 3.5. The dispersing acid may comprise a first acidic proton having a pKa of 1.1 to 4.6, such as 1.5 to 4.0, such as 1.8 to 3.5.

The dispersing acid may comprise a carboxylic acid, an oxyacid of phosphorus (such as phosphoric acid or phosphonic acid), or a combination thereof.

The thermally conductive, electrically insulative filler material and dispersing acid may complex to form a thermally conductive, electrically insulative filler material-dispersing acid complex. The dispersing acid may deprotonate in the aqueous medium of the composition to form a negative (or more negative) charge, and the deprotonated acid dispersant may form a complex with the thermally conductive, electrically insulative filler material. The complex may have an overall negative or more negative charge than the thermally conductive, electrically insulative filler material does itself.

The ratio of the weight of thermally conductive, electrically insulative filler material to moles of dispersing agent may be at least 0.25 g/mmol, such as at least 0.5 g/mmol, such as at least 1.0 g/mmol, such as at least 1.5 g/mmol, such as at least 1.75 g/mmol. The ratio of the weight of thermally conductive, electrically insulative filler material to moles of dispersing agent may be no more than 196 g/mmol, such as no more than 100 g/mmol, such as no more than 50 g/mmol, such as no more than 25 g/mmol, such as no more than 15 g/mmol, such as no more than 10 g/mmol, such as no more than 8.25 g/mmol, such as no more than 6.5 g/mmol, such as no more than 5.0 g/mmol. The ratio of the weight of thermally conductive, electrically insulative filler material to moles of dispersing agent may be in the amount of 0.25 to 196 g/mmol, such as 0.25 to 100 g/mmol, such as 0.25 to 50 g/mmol, such as 0.25 to 25 g/mmol, such as 0.25 to 15 g/mmol, such as 0.25 to 10 g/mmol, such as 0.25 to 8.25 g/mmol, such as 0.25 to 6.5 g/mmol, such as 0.25 to 5.0 g/mmol, such as 0.5 to 196 g/mmol, such as 0.5 to 100 g/mmol, such as 0.5 to 50 g/mmol, such as 0.5 to 25 g/mmol, such as 0.5 to 15 g/mmol, such as 0.5 to 10 g/mmol, such as 0.5 to 8.25 g/mmol, such as 0.5 to 6.5 g/mmol, such as 0.5 to 5.0 g/mmol, such as 1.0 to 196 g/mmol, such as 1.0 to 100 g/mmol, such as 1.0 to 50 g/mmol, such as 1.0 to 25 g/mmol, such as 1.0 to 15 g/mmol, such as 1.0 to 10 g/mmol, such as 1.0 to 8.25 g/mmol, such as 1.0 to 6.5 g/mmol, such as 1.0 to 5.0 g/mmol, such as 1.5 to 196 g/mmol, such as 1.5 to 100 g/mmol, such as 1.5 to 50 g/mmol, such as 1.5 to 25 g/mmol, such as 1.5 to 15 g/mmol, such as 1.5 to 10 g/mmol, such as 1.5 to 8.25 g/mmol, such as 1.5 to 6.5 g/mmol, such as 1.5 to 5.0 g/mmol, such as 1.75 to 196 g/mmol, such as 1.75 to 100 g/mmol, such as 1.75 to 50 g/mmol, such as 1.75 to 25 g/mmol, such as 1.75 to 15 g/mmol, such as 1.75 to 10 g/mmol, such as 1.75 to 8.25 g/mmol, such as 1.75 to 6.5 g/mmol, such as 1.75 to 5.0 g/mmol.

The pigment-to-binder (P:B) ratio as set forth in this invention may refer to the weight ratio of the pigment-to-binder in the electrocoat bath composition, and/or the weight ratio of the pigment-to-binder in the deposited wet film, and/or the weight ratio of the pigment to the binder in the dry, uncured deposited film, and/or the weight ratio of the pigment-to-binder in the cured film. The pigment-to-binder (P:B) ratio of the thermally conductive, electrically insulative filler material to the electrodepositable binder may be at least 0.20:1, such as at least 0.25:1, such as at least 0.30:1, such as at least 0.35:1, such as at least 0.40:1, such as at least 0.50:1, such as at least 0.60:1, such as at least 0.75:1, such as at least 1:1, such as at least 1.25:1, such as at least 1.5:1. The pigment-to-binder (P:B) ratio of the thermally conductive, electrically insulative filler material to the electrodepositable binder may be no more than 2.0:1, such as no more than 1.75:1, such no more than 1.5:1, such as no more than 4:3, such as no more than 1.25:1, such as no more than 1:1, such as no more than 0.75:1, such as no more than 0.70:1, such as no more than 0.60:1, such as no more than 0.55:1, such as no more than 0.50:1. The pigment-to-binder (P:B) ratio of the thermally conductive, electrically insulative filler material to the electrodepositable binder may be 0.2:1 to 2.0:1, such as 0.2:1 to 1.75:1, such as 0.2:1 to 1.50:1, such as 0.2:1 to 4:3, such as 0.2:1 to 1.25:1, such as 0.2:1 to 1:1, such as 0.2:1 to 0.75:1, such as 0.2:1 to 0.70:1, such as 0.2:1 to 0.60:1, such as 0.2:1 to 0.55:1, such as 0.2:1 to 0.50:1, such as 0.25:1 to 2.0:1, such as 0.25:1 to 1.75:1, such as 0.25:1 to 1.50:1, such a 0.25:1 to 4:3, such as 0.25:1 to 1.25:1, such as 0.25:1 to 1:1, such as 0.25:1 to 0.75:1, such as 0.25:1 to 0.70:1, such as 0.25:1 to 0.60:1, such as 0.25:1 to 0.55:1, such as 0.25:1 to 0.50:1, such as 0.3:1 to 2.0:1, such as 0.3:1 to 1.75:1, such as 0.3:1 to 1.50:1, such as 0.3:1 to 4:3, such as 0.3:1 to 1.25:1, such as 0.3:1 to 1:1, such as 0.3:1 to 0.75:1, such as 0.3:1 to 0.70:1, such as 0.3:1 to 0.60:1, such as 0.3:1 to 0.55:1, such as 0.3:1 to 0.50:1, such as 0.35:1 to 2.0:1, such as 0.35:1 to 1.75:1, such as 0.35:1 to 1.50:1, such as 0.35:1 to 4:3, such as 0.35:1 to 1.25:1, such as 0.35:1 to 1:1, such as 0.35:1 to 0.75:1, such as 0.35:1 to 0.70:1, such as 0.35:1 to 0.60:1, such as 0.35:1 to 0.55:1, such as 0.35:1 to 0.50:1, such as 0.4:1 to 2.0:1, such as 0.4:1 to 1.75:1, such as 0.4:1 to 1.50:1, such as 0.4:1 to 4:3, such as 0.4:1 to 1.25:1, such as 0.4:1 to 1:1, such as 0.4:1 to 0.75:1, such as 0.4:1 to 0.70:1, such as 0.4:1 to 0.60:1, such as 0.4:1 to 0.55:1, such as 0.4:1 to 0.50:1, such as 0.5:1 to 2.0:1, such as 0.5:1 to 1.75:1, such as 0.5:1 to 1.50:1, such as 0.5:1 to 4:3, such as 0.5:1 to 1.25:1, such as 0.5:1 to 1:1, such as 0.5:1 to 0.75:1, such as 0.5:1 to 0.70:1, such as 0.5:1 to 0.60:1, such as 0.5:1 to 0.55:1, such as 0.6:1 to 2.0:1, such as 0.6:1 to 1.75:1, such as 0.6:1 to 1.50:1, such as 0.6:1 to 4:3, such as 0.6:1 to 1.25:1, such as 0.6:1 to 1:1, such as 0.6:1 to 0.75:1, such as 0.6:1 to 0.70:1, such as 0.75:1 to 2.0:1, such as 0.75:1 to 1.75:1, such as 0.75:1 to 1.50:1, such as 0.75:1 to 4:3, such as 0.75:1 to 1.25:1, such as 0.75:1 to 1:1, such as 1:1 to 2.0:1, such as 1:1 to 1.75:1, such as 1:1 to 1.50:1, such as 1:1 to 4:3, such as 1:1 to 1.25:1, such as 1.25:1 to 2.0:1, such as 1.25:1 to 1.75:1, such as 1.25:1 to 1.50:1, such as 1.25:1 to 4:3, such as 1.50:1 to 2.0:1, such as 1.50:1 to 1.75:1.

The dispersing agent may be present in an amount of at least 0.1% by weight, such as at least 0.3% by weight, such as at least 0.5% by weight, such as at least 0.8% by weight, such as 1% by weight, based on the total solids weight of the composition. The dispersing agent may be present in an amount of no more than 10% by weight, such as no more than 7.5% by weight, such as no more than 5% by weight, such as no more than 3% by weight, such as no more than 2% by weight, such as no more than 1.5% by weight, based on the total solids weight of the composition. The dispersing agent may be present in an amount of 0.1% to 10% by weight, such as 0.1% to 7.5% by weight, such as 0.3% to 5% by weight, such as 0.3% to 5% by weight, such as 0.5% to 3% by weight, such as 0.1% to 3% by weight, such as 0.8% to 2% by weight, such as 1% to 1.5% by weight, based on the total solids weight of the composition.

The present invention is also directed to a cationic electrodepositable coating composition comprising a cationic electrodepositable binder comprising a cationic salt group-containing, film-forming polymer; a thermally conductive, electrically insulative filler material; and a dispersing agent, wherein the cationic electrodepositable coating composition is formed by the method comprising the steps of (1) heating an unneutralized cationic salt forming group-containing, film-forming polymer to an elevated temperature; (2) adding the dispersing agent to the unneutralized cationic salt forming group-containing, film-forming polymer with agitation to form a mixture; (3) adding the thermally conductive, electrically insulative filler material to the mixture at elevated temperature with agitation; and (4) dispersing the mixture of the cationic salt forming group-containing, film-forming polymer, the thermally conductive, electrically insulative filler material, and dispersing agent into an aqueous medium comprising water and a resin neutralizing acid with agitation, wherein cationic salt forming groups of the cationic salt forming group-containing, film-forming polymer are neutralized by the resin neutralizing acid to form the cationic salt group-containing, film forming polymer. The cationic binder may optionally further comprise a curing agent, and the curing agent may be added during or after any of steps 1 through 4. The thermally conductive, electrically insulative filler material and dispersing agent may optionally form a thermally conductive, electrically insulative filler material-dispersing agent complex, and/or the thermally conductive, electrically insulative filler material, dispersing agent, and cationic salt group-containing, film-forming polymer may optionally form a thermally conductive, electrically insulative filler material-dispersing agent-cationic salt group-containing, film-forming polymer complex.

Fire-Retardant Pigment

As used herein, “fire-retardant” refers to a material that slows down or stops the spread of fire or reduces its intensity. Fire retardants may be available as a powder that may be mixed with a composition, a foam, or a gel. In examples, when the compositions of the present invention include a fire-retardant, such compositions may form a coating on a substrate surface and such coating may function as a fire-retardant coating.

As set forth in more detail below, a fire-retardant can include a mineral, an organic compound, an organohalogen compound, an organophosphorous compound, or a combination thereof.

Suitable examples of minerals include huntite, hydromagnesite, various hydrates, red phosphorous, boron compounds such as borates, carbonates such as calcium carbonate and magnesium carbonate, and combinations thereof.

Suitable examples of organohalogen compounds include organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCGs), brominated epoxy oligomers (BEOs), tetrabromophthalic anyhydride, tetrabromobisphenol A (TBBPA) and hexabromocyclododecane (HBCD). Such halogenated flame retardants may be used in conjunction with a synergist to enhance their efficiency. Other suitable examples include antimony trioxide, antimony pentaoxide, and sodium antimonate.

Suitable examples of organophosphorous compounds include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

Suitable examples of organic compounds include carboxylic acid, dicarboxylic acid, melamine, and organonitrogen compounds.

Other suitable flame retardants include ammonium polyphosphate and barium sulfate.

According to the present invention, the fire-retardant pigment may have any particle shape or geometry. For example, the pigment may be a regular or irregular shape and may be spherical, ellipsoidal, cubical, platy, acicular (elongated or fibrous), rod-shaped, disk-shaped, prism-shaped, flake-shaped, irregular, rock-like, etc., agglomerates thereof, and any combination thereof.

The pigment may have a reported average particle size in at least one dimension of at least 0.01 microns, as reported by the manufacturer, such as at least 2 microns, such as at least 10 microns. The pigment may have a reported average particle size in at least one dimension of up to 100 microns or more, such as no more than 100 microns, such as no more than 50 microns, such as no more than 40 microns, such as no more than 25 microns. The pigment may have a reported average particle size in at least one dimension of 0.01 microns to 100 microns as reported by the manufacturer, such as 0.01 microns to 50 microns, such as 0.01 microns to 40 microns, such as 0.01 microns to 25 microns, such as 2 microns to 100 microns, such as 2 microns to 50 microns, such as 2 microns to 40 microns, such as 2 microns to 25 microns, such as 10 micron to 100 microns, such as 10 microns to 50 microns, such as 10 microns to 40 microns, such as 10 microns to 25 microns. Suitable methods of measuring average particle size include, for example, measurement using an instrument such as the Quanta 250 FEG SEM or an equivalent instrument.

The ratio of the weight of fire-retardant pigment to moles of dispersing agent may be at least 0.25 g/mmol, such as at least 0.5 g/mmol, such as at least 1.0 g/mmol, such as at least 1.5 g/mmol, such as at least 1.75 g/mmol. The ratio of the weight of fire-retardant pigment to moles of dispersing agent may be no more than 196 g/mmol, such as no more than 100 g/mmol, such as no more than 50 g/mmol, such as no more than 25 g/mmol, such as no more than 15 g/mmol, such as no more than 10 g/mmol, such as no more than 8.25 g/mmol, such as no more than 6.5 g/mmol, such as no more than 5.0 g/mmol. The ratio of the weight of fire-retardant pigment to moles of dispersing agent may be in the amount of 0.25 to 196 g/mmol, such as 0.25 to 100 g/mmol, such as 0.25 to 50 g/mmol, such as 0.25 to 25 g/mmol, such as 0.25 to 15 g/mmol, such as 0.25 to 10 g/mmol, such as 0.25 to 8.25 g/mmol, such as 0.25 to 6.5 g/mmol, such as 0.25 to 5.0 g/mmol, such as 0.5 to 196 g/mmol, such as 0.5 to 100 g/mmol, such as 0.5 to 50 g/mmol, such as 0.5 to 25 g/mmol, such as 0.5 to 15 g/mmol, such as 0.5 to 10 g/mmol, such as 0.5 to 8.25 g/mmol, such as 0.5 to 6.5 g/mmol, such as 0.5 to 5.0 g/mmol, such as 1.0 to 196 g/mmol, such as 1.0 to 100 g/mmol, such as 1.0 to 50 g/mmol, such as 1.0 to 25 g/mmol, such as 1.0 to 15 g/mmol, such as 1.0 to 10 g/mmol, such as 1.0 to 8.25 g/mmol, such as 1.0 to 6.5 g/mmol, such as 1.0 to 5.0 g/mmol, such as 1.5 to 196 g/mmol, such as 1.5 to 100 g/mmol, such as 1.5 to 50 g/mmol, such as 1.5 to 25 g/mmol, such as 1.5 to 15 g/mmol, such as 1.5 to 10 g/mmol, such as 1.5 to 8.25 g/mmol, such as 1.5 to 6.5 g/mmol, such as 1.5 to 5.0 g/mmol, such as 1.75 to 196 g/mmol, such as 1.75 to 100 g/mmol, such as 1.75 to 50 g/mmol, such as 1.75 to 25 g/mmol, such as 1.75 to 15 g/mmol, such as 1.75 to 10 g/mmol, such as 1.75 to 8.25 g/mmol, such as 1.75 to 6.5 g/mmol, such as 1.75 to 5.0 g/mmol.

The fire-retardant pigment may be present in the electrodepositable coating composition at a pigment-to-binder (P:B) ratio as described above.

Further Components of the Electrodepositable Coating Compositions

The electrodepositable coating composition according to the present invention may optionally comprise one or more further components in addition to the cationic or anionic electrodepositable binder and thermally conductive, electrically insulative filler and/or fire-retardant pigment described above.

According to the present invention, the electrodepositable coating composition comprises an aqueous medium comprising water and optionally one or more organic solvent(s). The aqueous medium be present in amounts of, for example, 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

For example, the organic solvent may comprise an ether or polyether comprising a hydroxyl group and a terminal group having the structure —O—R, wherein R is a C₁ to C₄ alkyl group, such as a C₁ to C₃ alkyl group, or two terminal hydroxyl groups. The polyether may comprise a homopolymer, block copolymer, or random copolymer. For example, the polyether may comprise a homopolymer of ethylene oxide or propylene oxide, or the polyether may comprise block or random copolymer comprising a combination of ethylene oxide and propylene oxide in a block or random pattern. Such organic solvents may comprise the structure:

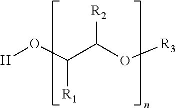

wherein R₁ and R₂ are each hydrogen or one of the R₁ and R₂ is hydrogen and the other is a methyl group; R₃ is H or a C₁ to C₄ alkyl group, such as a C₁ to C₃ alkyl group; and n is an integer from 1-50, such as from 1-40, such as from 1-30, such as from 1-20, such as from 1-12, such as from 1-8, such as from 1-6, such as from 1-4, such as from 2-50, such as from 2-40, such as from 2-30, such as from 2-20, such as from 2-12, such as from 2-8, such as from 2-6, such as from 2-4, such as from 3-50, such as from 3-40, such as from 3-30, such as from 3-20, such as from 3-12, such as from 3-8, such as from 3-6, such as from 3-4.

According to the present invention, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

The cationic electrodepositable coating composition may have a pH of 3.0 to 6.5, 3.0 to 6.0, such as such as 3.0 to 5.5, such as 3.0 to 5.0, such as 3.0 to 4.5, such as 3.0 to 4.0, such as 3.0 to 3.5, such as 3.5 to 6.5, such as 3.5 to 6.0, such as 3.5 to 5.5, such as 3.5 to 5.0, such as 3.5 to 4.5, such as 3.5 to 4.0, such as 4.0 to 6.5, such as 4.0 to 6.0, such as 4.0 to 5.5, such as 4.0 to 5.0, such as 4.0 to 4.5.

According to the present invention, the electrodepositable coating composition may optionally comprise a catalyst to catalyze the reaction between the curing agent and the polymers. Examples of catalysts suitable for cationic electrodepositable coating compositions include, without limitation, organotin compounds (e.g., dibutyltin oxide and dioctyltin oxide) and salts thereof (e.g., dibutyltin diacetate); other metal oxides (e.g., oxides of cerium, zirconium and bismuth) and salts thereof (e.g., bismuth sulfamate and bismuth lactate); or a cyclic guanidine as described in U.S. Pat. No. 7,842,762 at col. 1, line 53 to col. 4, line 18 and col. 16, line 62 to col. 19, line 8, the cited portions of which being incorporated herein by reference. Examples of catalysts suitable for anionic electrodepositable coating compositions include latent acid catalysts, specific examples of which are identified in WO 2007/118024 at and include, but are not limited to, ammonium hexafluoroantimonate, quaternary salts of SbF₆ (e.g., NACURE® XC-7231), t-amine salts of SbF₆ (e.g., NACURE® XC-9223), Zn salts of triflic acid (e.g., NACURE® A202 and A218), quaternary salts of triflic acid (e.g., NACURE® XC-A230), and diethylamine salts of triflic acid (e.g., NACURE® A233), all commercially available from King Industries, and/or mixtures thereof. Latent acid catalysts may be formed by preparing a derivative of an acid catalyst such as para-toluenesulfonic acid (pTSA) or other sulfonic acids. For example, a well-known group of blocked acid catalysts are amine salts of aromatic sulfonic acids, such as pyridinium para-toluenesulfonate. Such sulfonate salts are less active than the free acid in promoting crosslinking. During cure, the catalysts may be activated by heating.

According to the present invention, the electrodepositable coating composition may comprise other optional ingredients, such as a pigment composition and, if desired, various additives such as fillers, plasticizers, anti-oxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The pigment composition may comprise, for example, iron oxides, lead oxides, strontium chromate, carbon black, coal dust, titanium dioxide, barium sulfate, as well as color pigments such as cadmium yellow, cadmium red, chromium yellow and the like. The other additives mentioned above may be present in the electrodepositable coating composition in amounts of 0.01% to 3% by weight, based on total weight of the resin solids of the electrodepositable coating composition.

The present invention is directed to an electrodepositable coating composition comprising an electrodepositable binder comprising an ionic salt group-containing film-forming polymer and a curing agent; and a thermally conductive, electrically insulative filler material, a fire-retardant pigment, or a combination thereof; wherein the electrodepositable coating composition has a resin solids content of less than 30% by weight, based on the total weight of the electrodepositable coating composition, and a viscosity of greater than 2 cP at a shear rate of 0.1/s, as measured by the BATH VISCOSITY TEST METHOD, such as at least 5 cP, such as at least 8 cP, such as at least 9 cP, such as at least 15 cP, such as at least 20 cP.

The present invention is directed to an electrodepositable coating composition comprising an electrodepositable binder comprising an ionic salt group-containing film-forming polymer and a curing agent; and a thermally conductive, electrically insulative filler material, a fire-retardant pigment, or a combination thereof; wherein the electrodepositable coating composition has a resin solids content of less than 30% by weight, based on the total weight of the electrodepositable coating composition, and a viscosity of less than 15 cP at a shear rate of 1,000/s, as measured by the BATH VISCOSITY TEST METHOD, such as less than 12 cP, such as less than 10 cP, such as less than 8 cP, such as less than 6 cP, such as less than 4 cP.

As used herein, the term “BATH VISCOSITY TEST METHOD” refers to a measurement of the viscosity of the composition by measuring viscosity as a function of shear rate. The viscosity may be measured with an Anton-Paar MCR302 rheometer using a concentric cylinder (cup and bob) setup with temperature-control. The temperature ie held at a constant 32° C. The viscosity of the electrodepositable coating compositions are first measured at a constant shear rate of 0.1 s⁻¹ for 21 data points with duration set by the measurement device to stabilize the coating system to a steady state. Then, the viscosity was measured at a logarithmic ramp of shear rate from 0.1 to 1000 s⁻¹, varying the shear rate at a point spacing of 5 points per decade with duration set by device. The viscosity of each shear rate may be recorded and reported. The BATH VISCOSITY TEST METHOD is used in the examples section of the present application.

According to the present invention, the electrodepositable coating composition may be substantially free, essentially free, or completely free of tin. As used herein, an electrodepositable coating composition is substantially free of tin if tin is present in an amount of less than 0.1% by weight, based on the total weight of the resin blend solids. As used herein, an electrodepositable coating composition may be essentially free of tin if tin is present in an amount of less than 0.01% by weight, based on the total weight of the resin blend solids. As used here, an electrodepositable coating composition is completely free of tin if tin is not present in the composition, i.e., 0.00% by weight, based on the total resin blend solids.

According to the present invention, the electrodepositable coating composition may be substantially free, essentially free, or completely free of bismuth. As used herein, an electrodepositable coating composition is substantially free of bismuth if bismuth is present in an amount of less than 0.1% by weight, based on the total weight of the resin blend solids. As used herein, an electrodepositable coating composition may be essentially free of bismuth if bismuth is present in an amount of less than 0.01% by weight, based on the total weight of the resin blend solids. As used here, an electrodepositable coating composition is completely free of bismuth if bismuth is not present in the composition, i.e., 0.00% by weight, based on the total resin blend solids.

According to the present invention, the electrodepositable coating composition may be substantially free, essentially free, or completely free of metal pigment. As used herein, the term “metal pigment” refers to metal and metal alloy pigments that consist primarily of metal(s) in the elemental (zerovalent) state. The metal particles may include zinc, aluminum, cadmium, magnesium, beryllium, copper, silver, gold, iron, titanium, nickel, manganese, chromium, scandium, yttrium, zirconium, platinum, tin, and alloys thereof, as well as various grades of steel. As used herein, an electrodepositable coating composition is substantially free of metal pigment if metal pigment is present in an amount of less than 5% by weight, based on the total weight of the pigment of the composition. As used herein, an electrodepositable coating composition is essentially free of metal pigment if metal pigment is present in an amount of less than 1% by weight, based on the total weight of the pigment of the composition. As used here, an electrodepositable coating composition is completely free of metal pigment if metal pigment is not present in the composition, i.e., 0.00% by weight, based on the total weight of the pigment of the composition.

According to the present invention, the electrodepositable coating composition may be substantially free, essentially free, or completely free of silane dispersant. As used herein, an electrodepositable coating composition is substantially free of silane dispersant if silane dispersant is present, if at all, in an amount of less than 1% by weight, based on the total solids weight of the composition. As used herein, an electrodepositable coating composition is essentially free of silane dispersant if silane dispersant is present, if at all, in an amount of less than 0.1% by weight, based on the total solids weight of the composition. As used here, an electrodepositable coating composition is completely free of silane dispersant if silane dispersant is not present in the composition, i.e., 0.00% by weight, based on the total solids weight of the composition.

Method of Making Electrodepositable Coating Composition

The present invention is also directed to a method of making an electrodepositable coating composition. The method comprises the steps of (1) heating an unneutralized cationic film-forming binder comprising a cationic salt forming group-containing, film-forming polymer to an elevated temperature; (2) adding the dispersing agent to the unneutralized cationic salt forming group-containing, film-forming polymer with agitation to form a mixture; (3) adding the thermally conductive, electrically insulative filler material and/or a fire-retardant pigment to the mixture at elevated temperature with agitation; and (4) dispersing the mixture of the cationic salt forming group-containing, film-forming polymer, the thermally conductive, electrically insulative filler material and/or a fire-retardant pigment, and dispersing agent into an aqueous medium comprising water and a resin neutralizing acid with agitation, wherein cationic salt forming groups in the cationic salt forming group-containing, film-forming polymer are neutralized by the resin neutralizing acid to form a cationic salt group-containing, film forming polymer. The cationic binder may optionally further comprise a curing agent, and the curing agent may be added during or after any of steps 1 through 4. The thermally conductive, electrically insulative filler material and/or a fire-retardant pigment and dispersing agent may form a thermally conductive, electrically insulative filler material-dispersing agent complex or a fire-retardant pigment-dispering agent complex. The thermally conductive, electrically insulative filler material and/or a fire-retardant pigment, dispersing agent, and cationic salt group-containing, film-forming polymer may also form a thermally conductive, electrically insulative filler material-dispersing agent-cationic salt group-containing, film-forming polymer complex or a fire-retardant pigment-dispersing agent-cationic salt group-containing, film-forming polymer complex.

The method of the present invention eliminates the need to prepare a separate pigment composition (such as, e.g., a pigment paste or a grinding vehicle) by allowing for incorporation of the pigment without the need for conventional grinding and/or a conventional grinding resin into a commercially viable electrocoat feed. Presently, electrodepositable coating compositions are commercially supplied as a two-component (2K) or one-component (1K) product. In the case of the 2K system, a separate resin blend and a separate pigment paste are sold to the customer. These materials are then combined with water in a specified ratio by the customer to product a stable electrocoat bath. One-component systems are also provided by electrocoat suppliers to some customers. However, these 1K systems are still produced from two separate components, but the components are combined into a single electrocoat feed by the electrocoat suppliers before shipment to customers. Accordingly, these 1K systems are still actually manufactured from two components. In contrast, the cationic electrodepositable coating composition of the present invention may be a true one-component electrodepositable coating composition that has been produced without the use a separately milled pigment paste. As used herein, a “one component electrodepositable coating composition” refers to a pigmented electrodepositable coating composition that is manufactured as a single component of dispersed binder and pigment without a separate pigment-containing composition.

According to the present invention, the electrodepositable coating composition optionally may be substantially free, essentially free, or completely free of a grind resin. As used herein, the term “grind resin” refers to a resin chemically distinct from the main film-forming polymer that is used during milling of pigment to form a pigment paste. As used herein, an electrodepositable coating composition is substantially free of grind resin if grind resin is present, if at all, in an amount of no more than 5% by weight, based on the total resin solids weight of the composition. As used herein, an electrodepositable coating composition is essentially free of grind resin if grind resin is present, if at all, in an amount of no more than 3% by weight, based on the total resin solids weight of the composition. As used here, an electrodepositable coating composition is completely free of grind resin if grind resin is not present in the composition, i.e., 0.00% by weight, based on the total resin solids weight of the composition.

According to the present invention, the method of making an electrodepositable coating composition may further comprise a grinding and/or milling step following dispersing the mixture of the cationic salt forming group-containing, film-forming polymer, the thermally conductive, electrically insulative filler material and/or a fire-retardant pigment, and dispersing agent into an aqueous medium comprising water and a resin neutralizing acid with agitation, wherein cationic salt forming groups in the cationic salt forming group-containing, film-forming polymer are neutralized by the resin neutralizing acid to form a cationic salt group-containing film forming polymer. The optional grinding and/or milling step may result in a more stable electrocoat bath.

The thermally conductive, electrically insulative filler material and/or a fire-retardant pigment may also be incorporated into the electrodepositable coating composition of the present invention by standard methods used in the industry, such as preparing a pigment paste or grinding vehicle with or without grinding.

Substrates

The electrodepositable coating composition of the present invention may be applied onto a number of substrates. Accordingly, the present invention is further directed to a substrate that is coated, at least in part, with a coating deposited from the electrodepositable coating composition described herein. It will be understood that the electrodepositable coating composition can be applied onto a substrate as a monocoat or as a coating layer in a multi-layer coating composite. The electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present invention, the metal or metal alloy may comprise cold rolled steel, hot rolled steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 3XXX, 4XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present invention may also comprise titanium and/or titanium alloys. Other suitable non-ferrous metals include copper and magnesium, as well as alloys of these materials. Suitable metal substrates for use in the present invention include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

The substrate may comprise a battery or battery component. The battery may be, for example, an electric vehicle battery, and the battery component may be an electric vehicle battery component. The battery component may comprise, but is not limited thereto, a battery cell, a battery shell, a battery module, a battery pack, a battery box, a battery cell casing, a pack shell, a battery lid and tray, a thermal management system, a battery housing, a module housing, a module racking, a battery side plate, a battery cell enclosure, a cooling module, a cooling tube, a cooling fin, a cooling plate, a bus bar, a battery frame, an electrical connection, metal wires, or copper or aluminum conductors or cables.

Methods of Coating, Coatings and Coated Substrates

The present invention is also directed to methods for coating a substrate, such as any one of the electroconductive substrates mentioned above. According the present invention, such methods may comprise electrodepositing a coating derived from the electrodepositable coating composition as described above onto at least a portion of the substrate. The method may optionally further comprise subjecting the coating to curing conditions (e.g., heat) to form an at least partially cured coating on the substrate. According to the present invention, the method may comprise (a) electrodepositing onto at least a portion of the substrate a coating from the electrodepositable coating composition of the present invention, and may optionally comprise (b) heating the coated substrate to a temperature and for a time sufficient to at least partially cure the electrodeposited coating on the substrate. According to the present invention, the method may optionally further comprise (c) applying directly to the at least partially cured electrodeposited coating one or more pigment-containing coating compositions and/or one or more pigment-free coating compositions to form a primer and/or top coat over at least a portion of the at least partially cured electrodeposited coating, and (d) heating the coated substrate of step (c) to a temperature and for a time sufficient to cure the primer and/or top coat. The primer and/or topcoat layers may also be applied to the electrodeposited coating layer prior to heating step (b), and each of the layers may be cured simultaneously by heating the coatings for a time sufficient to cure the coating layers according to heating step (d).

According to the present invention, the cationic electrodepositable coating composition of the present invention may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, the film thickness of the electrodeposited coating, level and type of catalyst present in the composition and the like. For purposes of the present invention, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

According to the present invention, the anionic electrodepositable coating composition of the present invention may be deposited upon an electrically conductive substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 200° F. to 450° F. (93° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, film thickness of the electrodeposited coating, level and type of catalyst present in the composition and the like. For purposes of the present invention, all that is necessary is that the time be sufficient to effect cure of the coating on the substrate. For example, the curing time may range from 10 to 60 minutes, such as 20 to 40 minutes. The thickness of the resultant cured electrodeposited coating may range from 15 to 50 microns.

The electrodepositable coating compositions of the present invention may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood and plastic.

The present invention is further directed to a coating formed by depositing a coating from the electrodepositable coating composition described herein onto a substrate. The coating may be in a cured or at least partially cured state. Accordingly, the substrate may be coated with a coating comprising an at least partially cured electrodepositable binder and a thermally conductive, electrically insulative filler and/or a fire-retardant pigment.

The present invention is further directed to a substrate that is coated, at least in part, with a coating deposited from the electrodepositable coating composition described herein. The coating on the substrate may be in a cured or at least partially cured state. The coating comprises an at least partially cured electrodepositable binder and a thermally conductive, electrically insulative filler and/or a fire-retardant pigment.

The present invention is also directed to a substrate comprising a coating comprising the electrodepositable binder and thermally conductive, electrically insulating filler material. The coating may be applied from any of the electrodepositable coating compositions described herein.

The coating may be a dielectric coating (i.e., an electrically insulating coating). For example, the coating may have a dielectric strength of at least 1 kV at any of the dry film thicknesses described herein (such as, for example, 25 microns), as measured by a Sefelec Dielectrimeter RMG12AC-DC and in accordance ASTM D 149-09 Hipot test, such as at least 2 kV, such as at least 2.5 kV, such as at least 5 kV, such as at least 7 kV, such as at least 8 kV, such as at least 10 kV, such as at least 12 kV, or higher. For example, the coating may have a dielectric strength of at least 2 kV at a dry film thickness of 25 microns or less, as measured by a Sefelec Dielectrimeter RMG12AC-DC and in accordance ASTM D 149-09 Hipot test, such as at least 2.5 kV, such as at least 5 kV, such as at least 7 kV, such as at least 8 kV, such as at least 10 kV, such as at least 12 kV, or higher.

The coating may be thermally conductive. For example, the coating may have a thermal conductivity of at least 0.3 W/m·K, as measured according to ASTM D5470, such as at least 0.5 W/m·K, such as at least 0.7 W/m·K, such as at least 0.9 W/m·K, such as at least 1.5 W/m·K, or higher.

According to the present invention, a coating deposited from the electrodepositable coating composition may have a horizontal surface roughness of less than 100 microinches, as measured by the L-PANEL SURFACE ROUGHNESS TEST METHOD, such as less than 75 microinches, such as less than 60 microinches, such as less than 55 microinches.

According to the present invention, a coating deposited from the electrodepositable coating composition has a vertical surface roughness of less than 75 microinches, as measured by the L-PANEL SURFACE ROUGHNESS TEST METHOD, such as less than 60 microinches, such as less than 50 microinches.

According to the present invention, a substrate comprising an electrodeposited coating layer comprising an electrodepositable binder and a fire-retardant pigment may have less than 30 mm of coating loss when exposed to flame, as measured according to the FIRE EXPOSURE TEST METHOD, such as less than 25 mm, such as less than 20 mm, such as less than 15 mm, such as less than 10 mm, such as less than 8 mm.

The substrate can undergo various treatments prior to application of the electrodepositable coating composition. For instance, the substrate can be alkaline cleaned, deoxidized, mechanically cleaned, ultrasonically cleaned, solvent wiped, roughened, plasma cleaned or etched, exposed to chemical vapor deposition, plated, anodized, annealed, cladded, or any combination thereof prior to application of the electrodepositable coating composition. The substrate can be treated using any of the previously described methods prior to application of the electrodepositable coating composition such as by dipping the substrate in a cleaner and/or deoxidizer bath prior to applying the electrodepositable coating composition. The substrate can also be plated prior to applying the electrodepositable coating composition. As used herein, “plating” refers to depositing a metal over a surface of the substrate.

As discussed above, the substrate may comprise a battery or battery component. The battery may be, for example, an electric vehicle battery, and the battery component may be an electric vehicle battery component. The battery component may comprise, but is not limited thereto, a battery cell, a battery shell, a battery module, a battery pack, a battery box, a battery cell casing, a pack shell, a battery lid and tray, a thermal management system, a battery housing, a module housing, a module racking, a battery side plate, a battery cell enclosure, a cooling module, a cooling tube, a cooling fin, a cooling plate, a bus bar, a battery frame, an electrical connection, metal wires, or copper or aluminum conductors or cables. The electrodepositable coating composition may be applied over any of these substrates to form an electrically insulating coating (i.e., dielectric coating), a thermally conductive coating, or an electrically insulating and thermally conductive coating, as described herein.

Multi-Layer Coating Composites

As described above, the electrodepositable coating compositions of the present invention may be utilized in an electrocoating layer that is part of a multi-layer coating composite comprising a substrate with various coating layers. The coating layers may include a pretreatment layer, such as a phosphate layer (e.g., zinc phosphate layer or iron phosphate) or zirconium oxide layer, an electrocoating layer which results from the electrodepositable coating composition of the present invention, and suitable top coat layers (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The topcoat typically includes a film-forming polymer, crosslinking material and, if a colored base coat or monocoat, one or more pigments. According to the present invention, the primer layer is disposed between the electrocoating layer and the base coat layer. According to the present invention, one or more of the topcoat layers are applied onto a substantially uncured underlying layer. For example, a clear coat layer may be applied onto at least a portion of a substantially uncured basecoat layer (wet-on-wet), and both layers may be simultaneously cured in a downstream process.

Moreover, the topcoat layers may be applied directly onto the electrodepositable coating layer. In other words, the substrate lacks a primer layer. For example, a basecoat layer may be applied directly onto at least a portion of the electrodepositable coating layer.

It will also be understood that the topcoat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present invention, additional ingredients such as colorants and fillers may be present in the various coating compositions from which the topcoat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present invention. It should be noted that, in general, the colorant can be present in a layer of the multi-layer composite in any amount sufficient to impart the desired property, visual and/or color effect.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPP red BO”), titanium dioxide, carbon black, zinc oxide, antimony oxide, etc. and organic or inorganic UV opacifying pigments such as iron oxide, transparent red or yellow iron oxide, phthalocyanine blue and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

The colorant may be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions may include colorants such as pigments or dyes having a particle size of less than 150 nm, such as less than 70 nm, or less than 30 nm. Nanoparticles may be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of resin-coated nanoparticles may be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

According to the present invention, special effect compositions that may be used in one or more layers of the multi-layer coating composite include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions may provide other perceptible properties, such as reflectivity, opacity or texture. For example, special effect compositions may produce a color shift, such that the color of the coating changes when the coating is viewed at different angles. Example color effect compositions are identified in U.S. Pat. No. 6,894,086, incorporated herein by reference. Additional color effect compositions may include coated silica, coated alumina, a transparent liquid crystal pigment, a liquid crystal coating, and/or any composition wherein interference results from a refractive index differential within the material and not because of the refractive index differential between the surface of the material and the air.

According to the present invention, a photosensitive composition and/or photochromic composition, which reversibly alters its color when exposed to one or more light sources, can be used in a number of layers in the multi-layer composite. Photochromic and/or photosensitive compositions can be activated by exposure to radiation of a specified wavelength. When the composition becomes excited, the molecular structure is changed, and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

According to the present invention, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

As used herein, unless otherwise defined, the term “substantially free” means that the component is present, if at all, in an amount of less than 1% by weight, based on the total resin solids weight of the composition.

As used herein, unless otherwise defined, the term “essentially free” means that the component is present, if at all, in an amount of less than 0.1% by weight, based on the total resin solids weight of the composition.

As used herein, unless otherwise defined, the term completely free means that the component is not present in the composition, i.e., 0.00% by weight, based on the total resin solids weight of the composition.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” thermally conductive, electrically insulative filler material, “a” fire-retardant pigment, “a” dispersing agent, “an” ionic salt group-containing film-forming polymer, and “a” curing agent, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, an electrodepositable coating composition “deposited onto” a substrate does not preclude the presence of one or more other intervening coating layers of the same or different composition located between the electrodepositable coating composition and the substrate.

As used herein, the term “polymer” refers broadly to prepolymers, oligomers and both homopolymers and copolymers. It should be noted that the prefix “poly” refers to two or more.

As used herein, “adduct” means a product of a direct addition of two or more distinct molecules, resulting in a single reaction product containing all atoms of all components.

As used herein, the terms “resin solids” or “resin blend solids” include the electrodepositable binder, and any additional water-dispersible non-pigmented component(s).

Whereas specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

Illustrating the invention are the following examples, which, however, are not to be considered as limiting the invention to their details. Unless otherwise indicated, all parts and percentages in the following examples, as well as throughout the specification, are by weight.

### Examples

Resin System: Resin System I

Preparation of Crosslinker I. A blocked polyisocyanate crosslinker, suitable for use in electrodepositable coating resins, was prepared in the following manner. Components 2 and 3 listed in Table 1, below, were added to a flask set up for total reflux with stirring under nitrogen. The content of the flask was heated to a temperature of 35° C., and Component 1 was added dropwise so that the temperature increased due to the reaction exotherm and was maintained under 100° C. After the addition of Component 1 was complete, a temperature of 100° C. was established in the reaction mixture and the reaction mixture held at temperature until no residual isocyanate was detected by IR spectroscopy. Components 4 and 5 were then and the reaction mixture was allowed to stir for 30 minutes and cooled to ambient temperature.

TABLE 1
Components for the preparation of Crosslinker I

| | | Parts-by-weight |
|---|---|---|
| No. | Component | (grams) |
| 1 | Polymeric methylene diphenyl diisocyanate ¹ | 3283 |
| 2 | K Kat XK 620 (Zn amidine) | 8.12 |
| 3 | Triethylene glycol monomethyl ether ² | 4022.9 |
| 4 | Butyl carbitol formal | 29.4 |
| 5 | Bisphenol A - ethylene oxide adduct | 323.4 |
| | (1/6 molar ratio BPA/EtO) | |

¹ Lupranate M20, available from BASF Corporation
² Available from Aldrich

Preparation of a Cationic, Amine-Functionalized, Polyepoxide-Based Resin (Resin System I): A cationic, amine-functionalized, polyepoxide-based polymeric resin, suitable for use in formulating electrodepositable coating compositions, was prepared in the following manner. Components 1-4 listed in Table 2, below, were combined in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 1 hour. Component 5 was then introduced into the flask, followed by Components 6-7, and a temperature of 100° C. was established in the reaction mixture. Premixed components 8 and 9 were then added to the reaction mixture quickly and the reaction mixture was allowed to exotherm. A temperature of 110° C. was established in and the reaction mixture was held for 1 hour. After the hold, the content of the flask was poured out and cooled to room temperature.

TABLE 2
Components for the preparation of Resin System I

| | | |
|---|---|---|
| No. | Component | Parts-by-weight (grams) |

Resin Synthesis Stage

| | | |
|---|---|---|
| 1 | Bisphenol A diglycidyl ether¹ | 1874.77 |
| 2 | Bisphenol A | 808.92 |
| 3 | Bisphenol A - ethylene oxide adduct | 305 |
| | (1/6 molar ratio BPA/EtO) | |
| 4 | Ethyl triphenyl phosphonium bromide | 1.83 |
| 5 | Bisphenol A - ethylene oxide adduct | 420.74 |
| | (1/6 molar ratio BPA/EtO) | |
| 6 | Crosslinker I² | 3762.16 |
| 7 | Butyl carbitol formal | 341.6 |
| 8 | N-(3-Aminopropyl)diethanolamine³ | 66.4 |
| 9 | Methyl ethanol amine | 143.67 |

¹EPON 828, available from Hexion Corporation.
²Ses synthesis of Crosslinker I, above.
³Available from Huntsman or Air Products

Resin System: Resin System II

Preparation of Crosslinker II: A blocked polyisocyanate crosslinker, suitable for use in electrodepositable coating resins, was prepared in the following manner. Components 2, 3a, and 3b listed in Table 3, below, were added to a flask set up for total reflux with stirring under nitrogen. The content of the flask was heated to a temperature of 35° C., and Component 1 was added dropwise so that the temperature increased due to the reaction exotherm and was maintained under 100° C. After the addition of Component 1 was complete, component 4 was added and a temperature of 100° C. was established in the reaction mixture. The reaction mixture was held at temperature until no residual isocyanate was detected by IR spectroscopy. Components 5a and 5b were then added and the reaction mixture was allowed to stir for 30 minutes and cooled to ambient temperature.

TABLE 3
Components for the preparation of Crosslinker II

| | | Parts-by-weight |
|---|---|---|
| No. | Component | (grams) |
| 1 | Polymeric methylene diphenyl diisocyanate ¹ | 670 |
| 2 | K Kat XK 620 (Zn amidine) | 1.38 |
| 3a | Triethylene glycol monomethyl ether ² | 574.7 |
| 3b | Kollisolv PEG 400³ | 300 |
| 4 | Butyl carbitol formal | 6 |
| 5a | Bisphenol A - ethylene oxide adduct | 66 |
| | (1/6 molar ratio BPA/EtO) | |
| 5b | Propylene glycol methyl ether | 80.9 |

¹ Lupranate M20, available from BASF Corporation
² Available from Aldrich
³Available from BASF Corporation

Preparation of a Cationic, Amine-Functionalized, Polyepoxide-Based Resin (Resin System II): A cationic, amine-functionalized, polyepoxide-based polymeric resin, suitable for use in formulating electrodepositable coating compositions, was prepared in the following manner. Components 1-4 listed in Table 4, below, were combined in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 1 hour. Component 5 was then introduced into the flask, followed by Components 6-7, and a temperature of 100° C. was established in the reaction mixture. Premixed components 8 and 9 were then added to the reaction mixture quickly and the reaction mixture was allowed to exotherm. A temperature of 110° C. was established in and the reaction mixture was held for 1 hour. Component 10 was then added and allowed to mix for 15 minutes. After the hold, the content of the flask was poured out and cooled to room temperature.

TABLE 4
Components for the preparation of Resin System II

| | | |
|---|---|---|
| No. | Component | Parts-by-weight (grams) |

Resin Synthesis Stage

| | | |
|---|---|---|
| 1 | Bisphenol A diglycidyl ether¹ | 614.68 |
| 2 | Bisphenol A | 265.22 |
| 3 | Bisphenol A - ethylene oxide adduct | 100 |
| | (1/6 molar ratio BPA/EtO) | |
| 4 | Ethyl triphenyl phosphonium bromide | 0.6 |
| 5 | Bisphenol A - ethylene oxide adduct | 145.4 |
| | (1/6 molar ratio BPA/EtO) | |
| 6 | Crosslinker II² | 1093.25 |
| 7 | Butyl carbitol formal | 112 |
| 8 | N-(3-Aminopropyl)diethanolamine³ | 21.77 |
| 9 | Methyl ethanol amine | 47.1 |
| 10 | Propylene glycol methyl ether | 295.23 |

¹EPON 828, available from Hexion Corporation.
²Ses synthesis of Crosslinker II, above.
³Available from Huntsman or Air Products

Resin System: Resin System III

Preparation of a Cationic, Amine-Functionalized, Polyepoxide-Based Resin (Resin System III): A cationic, amine-functionalized, polyepoxide-based polymeric resin, suitable for use in formulating electrodepositable coating compositions, was prepared in the following manner. Components 1-4 listed in Table 5, below, were combined in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 90 minutes. Component 5 was then introduced into the flask, followed by Components 6-7, and a temperature of 100° C. was established in the reaction mixture. Premixed components 8 and 9 were then added to the reaction mixture quickly and the reaction mixture was allowed to exotherm. A temperature of 110° C. was established in and the reaction mixture was held for 1 hour. A temperature of 85° C. was established and then Component 10 was then added and allowed to mix for 15 minutes. Component 11 was then added dropwise and allowed to mix for 10 minutes. A temperature of 60° C. was then established. Prior to this, components 12 and 13 were pre-mixed for 1 hour. The solution of components 12 and 13 was heated to 60° C. and then added to the resin mixture and mixed for 1 hour. After that, component 14 was added maintaining a temperature between 50° C. to 60° C. and let to mix for an additional hour. After the hold, the content of the flask was poured out and cooled to room temperature.

TABLE 5
Components for the preparation of Resin System III

| | | |
|---|---|---|
| No. | Component | Parts-by-weight (grams) |

Resin Synthesis Stage

| | | |
|---|---|---|
| 1 | Bisphenol A diglycidyl ether¹ | 338.1 |
| 2 | Bisphenol A | 145.9 |
| 3 | Bisphenol A - ethylene oxide adduct | 55 |
| | (1/6 molar ratio BPA/EtO) | |
| 4 | Ethyl triphenyl phosphonium bromide | 0.3 |
| 5 | Bisphenol A - ethylene oxide adduct | 76.8 |
| | (1/6 molar ratio BPA/EtO) | |
| 6 | Crosslinker II² | 678.7 |
| 7 | Butyl carbitol formal | 61.6 |
| 8 | N-(3-Aminopropyl)diethanolamine³ | 12 |
| 9 | Methyl ethanol amine | 25.9 |
| 10 | Propylene glycol methyl ether | 171.5 |
| 11 | Phosphoric Acid (85%) | 10.9 |
| 12 | Deionized Water | 1165.7 |
| 13 | Sulfamic Acid | 19.1 |
| 14 | Deionized Water | 690.4 |

¹EPON 828, available from Hexion Corporation.
²Ses synthesis of Crosslinker II, above.
³Available from Huntsman or Air Products

Electrodepositable Coating Compositions

Sources of Formulation Pigments, Additives, and Chemicals: Chemicals used for formulation of electrocoat baths were obtained from various suppliers. The solvent Dowanol PM was obtained from Dow Chemical Company at 98% purity. Phosphoric acid (85% active in water) was obtained from PPG Industries. Sulfamic acid was obtained from PPG Industries. PTX25 PolarTherm Boron Nitride Powder and CoolFlow CF500 boron nitride powder were obtained from Momentive Performance Materials Inc. Nabalox 644-20C and APYRAL 20X were obtained from Nabaltec AG.

PTX25 Boron Nitride Pigmented Composition 1: A stainless steel beaker (1-liter) was loaded with 250 grams of Resin System I which had been warmed to 90° C. using thermocouple and heating mantle. A 1.5-inch Cowles blade was used to agitate the resin at 2500 RPM powered by a Fawcett air motor (Model 103A). The following ingredients were added in the order listed. To the resin was added, 36.3 grams of Dowanol PM which was allowed to incorporate for ten minutes. Next, 3.4 grams of phosphoric acid (85% active in water) was added dropwise to the resin and mixed for ten minutes. Next, 75 grams of deionized water was added to the resin over ten minutes. Next, 150 grams of PTX25 PolarTherm Boron Nitride Powder was added to the resin over ten minutes. This mixture was agitated for one hour. In a separate stainless steel beaker (1-liter), 3.28 grams of sulfamic acid was added to 465.2 grams of deionized water and mixed for one hour under mild agitation. The sulfamic acid solution was then heated to 60° C. using a thermocouple and heating mantle. After an adequate dispersion was achieved with the resin mixture, the heated acid solution was slowly poured into the resin mixture while continuing agitation. The acidified resin mixture was held for one hour at 60° C. while continuing agitation. After the one hour hold, the resin mixture was thinned down with 614 grams of deionized water over 15 minutes, allowing the temperature to fluctuate naturally. Tin-catalyst was then added by adding 11.86 grams of E6278I (a dibutyl tin oxide [DBTO] paste available from PPG Industries which is 7.2 wt. % DBTO) to provide a Sn loading of 0.7 weight % on resin solids. Finally, an additional 614 grams of deionized water was added to make a finished electrocoat bath at 20 wt. % solids. The final bath pH was 4.4 and the conductivity was 1140 μS.

Non-Pigmented Comparative Composition 2: A stainless steel beaker (0.6-liter) was loaded with 50 grams of Resin System I which had been warmed to 90° C. using thermocouple and heating mantle. A 1.5-inch Cowles blade was used to agitate the resin at 2500 RPM powered by a Fawcett air motor (Model 103A). The following ingredients were added in the order listed. To the resin was added, 7.3 grams of Dowanol PM which was allowed to incorporate for ten minutes. Next, 0.7 grams of phosphoric acid (85% active in water) was added dropwise to the resin and mixed for ten minutes. Next, 5.8 grams of deionized water was added to the resin over ten minutes. This mixture was agitated for one hour. In a separate stainless steel beaker (0.6-liter), 0.66 grams of sulfamic acid was added to 130.6 grams of deionized water and mixed for one hour under mild agitation. The sulfamic acid solution was then heated to 60° C. using a thermocouple and heating mantle. After an adequate dispersion was achieved with the resin mixture, the heated acid solution was slowly poured into the resin mixture while continuing agitation. The acidified resin mixture was held for one hour at 60° C. while continuing agitation. After the one hour hold, the resin mixture was thinned down with 48.7 grams of deionized water over 15 minutes, allowing the temperature to fluctuate naturally. Tin-catalyst was then added by adding 2.4 grams of E6278I (a dibutyl tin oxide [DBTO] paste available from PPG Industries which is 7.2 wt. % DBTO) to provide a Sn loading of 0.7 weight % on resin solids. Next, an additional 48.7 grams of deionized water was added to make an electrocoat bath at 20 wt. % solids. The bath pH was 5.1 and the conductivity was 1448 μS. The electrocoat was then further diluted with 1080 grams of deionized water to a final bath solids of 4.3%.

Control A Comparative Composition 3: This electrocoat is commercially available from PPG Industries under the name Framecoat II and is supplied as a 2K. The Electrocoat bath was prepared by mixing 1801 grams of CR681 resin (available from PPG), CP524 paste (243.8 grams, available from PPG) and deionized water (1755.2 grams). The P:B of this paint was 0.1:1.0. Control B was used according to the technical bulletin.

CoolFlow CF500 Boron Nitride Pigmented Composition 4: A stainless steel beaker (2.5-liter) was loaded with 367.4 grams of Resin System II and 80 grams of Crosslinker II which had been warmed to 60° C. using thermocouple and heating mantle. A 1.5-inch Cowles blade was used to agitate the resin at 2500 RPM powered by a Fawcett air motor (Model 103A). The following ingredients were added in the order listed. To the resin was added, 3.8 grams of phosphoric acid (85% active in water) was added dropwise to the resin and mixed for ten minutes. Next, 46 grams of deionized water was added to the resin over ten minutes. Next, 280 grams of CoolFlow CF500 Boron Nitride Powder was added to the resin over ten minutes. This mixture was agitated for one hour, allowing the temperature to heat to a maximum temperature of 90° C. In a separate stainless steel beaker (1-liter), 5.93 grams of sulfamic acid was added to 466.1 grams of deionized water and mixed for one hour under mild agitation. The sulfamic acid solution was then heated to 60° C. using a thermocouple and heating mantle. After an adequate dispersion was achieved with the resin mixture, the heated acid solution was slowly poured into the resin mixture while continuing agitation. The acidified resin mixture was held for one hour at 60° C. while continuing agitation. After the one hour hold, the resin mixture was thinned down with 469.9 grams of deionized water over 15 minutes, allowing the temperature to fluctuate naturally. After that, an additional 574.3 grams of deionized water was added slowly over 15 minutes. Tin-catalyst was then added by adding 18.8 grams of E6278 (a dibutyl tin oxide [DBTO] paste available from PPG Industries) to provide a Sn loading of 0.72 weight % on resin solids. 22.4 grams of butyl carbitol formal were then added to the bath and it was allowed to stir for 16 hours. The electrocoat bath was 30 wt. % solids. The final bath pH was 5.09 and the conductivity was 1349 μS.

Alumina Pigmented Composition 5: A stainless steel beaker (2.5-liter) was loaded with 229.6 grams of Resin System II and 50 grams of Crosslinker II which had been warmed to 60° C. using thermocouple and heating mantle. A 1.5-inch Cowles blade was used to agitate the resin at 2500 RPM powered by a Fawcett air motor (Model 103A). The following ingredients were added in the order listed. To the resin was added, 2.5 grams of phosphoric acid (85% active in water) was added dropwise to the resin and mixed for ten minutes. Next, 28.8 grams of deionized water was added to the resin over ten minutes. Next, 500 grams of Nabalox 644-20C was added to the resin over ten minutes. This mixture was agitated for one hour allowing the temperature to heat to a maximum temperature of 90° C. In a separate stainless steel beaker (1-liter), 4.45 grams of sulfamic acid was added to 263.2 grams of deionized water and mixed for one hour under mild agitation. The sulfamic acid solution was then heated to 60° C. using a thermocouple and heating mantle. After an adequate dispersion was achieved with the resin mixture, the heated acid solution was slowly poured into the resin mixture while continuing agitation. The acidified resin mixture was held for one hour at 60° C. while continuing agitation. After the one hour hold, the resin mixture was thinned down with 810.6 grams of deionized water over 15 minutes, allowing the temperature to fluctuate naturally. After that, an additional 630.5 grams of deionized water was added slowly over 15 minutes. Tin-catalyst was then added by adding 11.8 grams of E6278 (a dibutyl tin oxide [DBTO] paste available from PPG Industries) to provide a Sn loading of 0.72 weight % on resin solids. After that, 100 grams of Resin System III was added to the bath.

Aluminum Hydroxide Pigmented Composition 6: A stainless steel beaker (2.5-liter) was loaded with 367.4 grams of Resin System II and 80 grams of Crosslinker II which had been warmed to 60° C. using thermocouple and heating mantle. A 1.5-inch Cowles blade was used to agitate the resin at 2500 RPM powered by a Fawcett air motor (Model 103A). The following ingredients were added in the order listed. To the resin was added, 3.8 grams of phosphoric acid (85% active in water) was added dropwise to the resin and mixed for ten minutes. Next, 46 grams of deionized water was added to the resin over ten minutes. Next, 400 grams of APYRAL 20X was added to the resin over ten minutes. This mixture was agitated for one hour allowing the temperature to heat to a maximum temperature of 90° C. In a separate stainless steel beaker (1-liter), 5.93 grams of sulfamic acid was added to 564.3 grams of deionized water and mixed for one hour under mild agitation. The sulfamic acid solution was then heated to 60° C. using a thermocouple and heating mantle. After an adequate dispersion was achieved with the resin mixture, the heated acid solution was slowly poured into the resin mixture while continuing agitation. The acidified resin mixture was held for one hour at 60° C. while continuing agitation. After the one hour hold, the resin mixture was thinned down with 551.7 grams of deionized water over 15 minutes, allowing the temperature to fluctuate naturally. After that, an additional 674.26 grams of deionized water was added slowly over 15 minutes. Tin-catalyst was then added by adding 18.8 grams of E6278 (a dibutyl tin oxide [DBTO] paste available from PPG Industries) to provide a Sn loading of 0.72 weight % on resin solids.

Non-pigmented Comparative Composition 7: This Electrocoat was prepared by mixing Resin System III (1060 grams), deionized water (1120 grams), and tin-catalyst by adding E6278 (a dibutyl tin oxide [DBTO] paste available from PPG Industries) (20.36 grams) to provide a Sn loading of 0.72 weight % on resin solids. The resulting bath was 20% solids.

Characterization of Electrocoat Composition Rheological Properties: Compositions 3, 4, 5, and 6 were characterized by measuring flow curves of the liquid baths determined by measuring viscosity as a function of shear rate. Viscosity was measured with an Anton-Paar MCR302 rheometer using a concentric cylinder (cup and bob) setup with temperature-control. The temperature was a constant 32° C. The viscosity of the electrodepositable coating compositions were first measured at a constant shear rate of 0.1 s⁻¹ for 21 data points with duration set by device, to stabilize the coating system to a steady state. Then, the viscosity was measured at a logarithmic ramp of shear rate from 0.1 to 1000 s⁻¹, varying the shear rate at a point spacing of 5 points per decade with duration set by device. The results can be found in Table 6.

TABLE 6
Rheological Characterization

| | | |
|---|---|---|
| Composition | Shear Rate | Viscosity (mPa*s or cP) |

| | | | |
|---|---|---|---|
| Comp. 3 | 0.1 | s⁻¹ | 2 |
| Comp. 3 | 1000 | s⁻¹ | 2 |
| Comp. 4 | 0.1 | s⁻¹ | 24.21 |
| Comp. 4 | 1000 | s⁻¹ | 6.87 |
| Comp. 5 | 0.1 | s⁻¹ | 21.66 |
| Comp. 5 | 1000 | s⁻¹ | 3.16 |
| Comp. 6 | 0.1 | s⁻¹ | 9.85 |
| Comp. 6 | 1000 | s⁻¹ | 4.77 |

The results in Table 6 demonstrate the unique non-Newtonian flow behavior in the novel compositions compared to the commercially available comparative composition 7.

Evaluation of Bath Stability

Evaluation of Bath Stability (The L-Panel Surface Roughness Test Method): Metal substrate panels (e.g., CRS) may optionally be pretreated with a pretreatment composition (e.g., a zinc phosphate pretreatment composition) and cut into half to yield a 4″ by 6″ panel. Then, 0.25 inches may be removed from each side of the panel resulting in a panel that was 3.5″ by 6″, which may be bent into an “L” shape yielding a 4-in vertical surface and 2-inch horizontal surface. This panel may be submerged into the electrocoat bath that is under agitation, and the agitation may be stopped. After three minutes of sitting in the unagitated bath, electrodeposition may proceed. A rectifier may be u used to apply the electrical current to the electrodepositable coating bath to coat the substrate. The target film build may be from 0.5 to 0.7 mils (12.7 to 17.8 microns) on the vertical face. This film thickness may be deposited by using the voltage/temperature/current conditions for a DFT of 25.4 microns (two-minute condition), but for one minute. The exact coating conditions may vary by composition. After the panels are electrocoated, the panels may be rinsed with deionized water and baked at 350° F. for 30 minutes in an electric oven. The roughness of the horizontal and vertical surfaces may be measured using a Precision Surtronic 25 Profilometer available from Taylor Hobson. The instrument may referenced using 3-inch silicon wafer available from Ted Pella Inc. (Product Number 16013), which had a roughness of 1.0±0.7 microinches after 10 repeat measurements. This test method is referred to herein as the L-PANEL SURFACE ROUGHNESS TEST METHOD. A summary of expected conditions and measured values is included in the table below.

TABLE 7
Comparison of electrodeposition conditions and cured film roughness

| | | | | | Vertical | Horizontal |
|---|---|---|---|---|---|---|
| | | | | | Surface | Surface |
| | | | | Bath | Roughness | Roughness |
| Compo- | Voltage | Current | Time | Temp. | (micro- | (micro- |
| sition | (V) | (amps) | (min.) | (° F.) | inches) | inches) |
| Comp. 3 | 200 V | 0.5 amps | 1.0 | 90 | 20 | 20 |
| Comp. 4 | 200 V | 0.5 amps | 1.0 | 90 | 53 | 45 |

Since electrodepositable coating compositions are often applied to parts with complex shapes having both horizontal and vertical surfaces, it is desirable to have comparable roughness irrespective of the orientation of the surface to be coated. A large difference between the vertical and horizontal surface roughness of an electrodeposited coating indicates that the bath lacks stability and does not provide performance that approaches a standard electrodepositable coating composition as demonstrated in Control A comparative composition 3.

Evaluation of Thermal Conductivity of Electrocoat Compositions

Preparation of Coatings for Thermal Conductivity Testing: Comparative Composition 1 and Comparative Composition 2 were used to electrocoat tin plated cold rolled steel panels. Panels were cut in half to a size of 4″ by 6″. A rectifier (Xantrax Model XFR600-2, Elkhart, Indiana, or Sorensen XG 300-5.6, Ameteck, Berwyn, Pennsylvania) which was DC-power supplied was used to apply the electrocodepositable coating at 90° F. After panels were electrocoated, these panels were rinsed with deionized water and baked at 350° F. for 30 minutes in an electric oven (Despatch Model LFD-1-42). The exact deposition conditions can be found in Table 8 for each run. After baking the coatings, free films were obtained by cleanly removing the coating from the substrate in a non-destructive manner.

TABLE 8
Electrodeposition conditions

| | | Current | | Dry Film Build |
|---|---|---|---|---|
| Composition | Voltage (V) | (amps) | Time | (mils) |
| Comp. 1 | 50 V | 0.5 amps | 2 minutes | 0.5 |
| Comp. 1 | 100 V | 0.5 amps | 2 minutes | 0.65 |
| Comp. 1 | 200 V | 0.5 amps | 2 minutes | 0.91 |
| Comp. 1 | 275 V | 0.5 amps | 2 minutes | 1.6 |
| Comp. 2 | 50 V | 0.5 amps | 2 minutes | 0.5 |
| Comp. 2 | 100 V | 0.5 amps | 2 minutes | 0.8 |
| Comp. 2 | 200 V | 0.5 amps | 2 minutes | 1.12 |

Evaluation of Thermal Conductivity of Comparative Composition 1 and 2: Bulk thermal conductivity of the cured free films were measured by ASTM D5470 method on a Thermal Interface Materials Analyzer from Analysis Tech. The thermal resistance of film samples with a range of thickness was measured, and then the bulk thermal conductivity is the reciprocal value of the slope by plotting the thermal resistance versus sample thickness. The measured results can be found in Table 9.

TABLE 9
Thermal Conductivity Results

| | | | Bulk |
|---|---|---|---|
| | Dry Film | Thermal | Thermal |
| | Build | Resistance | Conductivity |
| Composition | (m) | (K-m\hat{ }2/W) | (W/m-K) |
| Comp. 1 | 1.4E−05 | 7.3E−05 | 0.32 W/m-K |
| Comp. 1 | 1.7E−05 | 1.1E−04 | |
| Comp. 1 | 2.4E−05 | 8.4E−05 | |
| Comp. 1 | 4.1E−05 | 1.7E−04 | |
| Comp. 2 | 1.3E−05 | 1.1E−04 | 0.22 W/m-K |
| Comp. 2 | 2.1E−05 | 1.1E−04 | |
| Comp. 2 | 2.9E−05 | 1.8E−04 | |

The results in Table 9 demonstrate that by using high loadings of boron nitride pigment within the electrocoat composition, bulk thermal conductivity of deposited coatings are significantly increased compared to the same electrocoat system without boron nitride pigment.

Evaluation of Dielectric Properties of Electrocoat Compositions

Preparation of Coatings for Dielectric Breakdown Testing: Comparative Compositions 3, 4, 5, 6, and 7 were used to electrodeposit coatings in triplicates over CRS panels pretreated with zinc phosphate (C700/DI; item no. 28630 available from ACT, Hillsdale, MI.). Panels were cut in half to a size of 4″ by 6″. A rectifier (Xantrax Model XFR600-2, Elkhart, Indiana, or Sorensen XG 300-5.6, Ameteck, Berwyn, Pennsylvania) which was DC-power supplied was used to apply the electrocodepositable coating at specific bath temperatures. After panels were electrocoated, these panels were rinsed with deionized water and baked at 350° F. for 30 minutes in an electric oven (Despatch Model LFD-1-42). The exact deposition conditions for each run can be found in Table 10.

TABLE 10
Electrodeposition conditions

| | | | | | | Average |
|---|---|---|---|---|---|---|
| | | | | | | Dry |
| | | | | | | Film |
| Compo- | Panel | Voltage | Current | | Bath | Build |
| sition | ID | (V) | (amps) | Time | Temperature | (mils) |
| Comp. 3 | 1, 2, 3 | 200 V | 0.5 amps | 2 minutes | 90 F. | 1.0 |
| Comp. 4 | 1 | 150 V | 0.5 amps | 2 minutes | 90 F. | 0.65 |
| Comp. 4 | 2 | 200 V | 0.5 amps | 2 minutes | 90 F. | 0.8 |
| Comp. 4 | 3 | 200 V | 0.5 amps | 2 minutes | 95 F. | 1.0 |
| Comp. 5 | 1, 2, 3 | 200 V | 4 amps | 10 seconds | 95 F. | 1.1 |
| Comp. 6 | 1, 2, 3 | 100 V | 0.5 amps | 2 minutes | 90 F. | 1.0 |
| Comp. 7 | 1, 2, 3 | 150 V | 0.5 amps | 2 minutes | 90 F. | 1.0 |

Dielectric breakdown testing: The coatings prepared for dielectric breakdown testing were evaluated for dielectric strength, as measured by a Sefelec Dielectric Strength Tester RMG12AC-DC and in accordance with ASTM D149-09 Dielectric Breakdown Voltage and Dielectric Strength test. The parameters of the testing were as follows: Voltage limit 12.0 kV DC, Iₘₐₓ Limit: 0.5 mA, 20 second ramp, 20 second dwell, and 2 second fall. If the film ruptured, the voltage at which the rupture occurred was reported. Three measurements were taken from each sample. Results are reported in Table 11 below.

TABLE 11
Electrodeposition conditions

| | | | | | Average | Max kV |
|---|---|---|---|---|---|---|
| | | Break- | Break- | Break- | Break- | Break- |
| | Panel | down | down | down | down | down |
| Composition | ID | kV | kV | kV | kV | Reading |
| Comp 3 | 1 | 3.53 | 2.6 | 3.49 | 3.21 | 3.53 |
| Comp 3 | 2 | 3.49 | 4.77 | 3.51 | 3.92 | 4.77 |
| Comp 3 | 3 | 1.67 | 3.08 | 4.09 | 2.95 | 3.36 |
| Comp 4 | 1 | 5.47 | 3.65 | 6.11 | 5.08 | 6.11 |
| Comp 4 | 2 | 3.56 | 5.92 | 4.56 | 4.68 | 5.92 |
| Comp 4 | 3 | 8.23 | 6.03 | 5.96 | 6.74 | 8.23 |
| Comp 6 | 1 | 5.93 | 8.55 | 3.56 | 6.01 | 8.55 |
| Comp 6 | 2 | 8.48 | 2.65 | 3.5 | 4.88 | 8.48 |
| Comp 6 | 3 | 5.06 | 6.02 | 2.38 | 4.49 | 6.02 |
| Comp 7 | 1 | 5.1 | 2.68 | 2.58 | 3.45 | 5.1 |
| Comp 7 | 2 | 3.32 | 2.35 | 3.96 | 3.21 | 3.96 |
| Comp 7 | 3 | 2.06 | 4.54 | 3.95 | 3.52 | 4.54 |

The results in Table 11 demonstrate that by using high loadings of electrically insulating pigment within the electrocoat composition, such as boron nitride or aluminum hydroxide, resistance to dielectric breakdown can be greatly improved compared to commercial electrocoat and unpigmented compositions.

Evaluation of Electrocoat Composition's Resistance to High Temperature and Fire Exposure

Preparation of Coatings for High Temperature Fire Exposure Testing: Comparative Compositions 3, 4, 5 and 6 were used to electrodeposit coatings in duplicate over CRS panels pretreated with zinc phosphate (C700/DI; item no. 28630 available from ACT, Hillsdale, MI.). Panels were cut in half to a size of 4″ by 6″. A rectifier (Xantrax Model XFR600-2, Elkhart, Indiana, or Sorensen XG 300-5.6, Ameteck, Berwyn, Pennsylvania) which was DC-power supplied was used to apply the electrocodepositable coating at specific bath temperatures. After panels were electrocoated, these panels were rinsed with deionized water and baked at 350° F. for 30 minutes in an electric oven (Despatch Model LFD-1-42). The exact deposition conditions for each run can be found in Table 12.

TABLE 12
Electrodeposition conditions

| | | | | | | Average |
|---|---|---|---|---|---|---|
| | | | | | | Dry |
| | | | | | | Film |
| Compo- | Panel | Voltage | Current | | Bath | Build |
| sition | ID | (V) | (amps) | Time | Temperature | (mils) |
| Comp. 3 | 1, 2 | 200 V | 0.5 amps | 2 minutes | 90 F. | 1.0 |
| Comp. 4 | 1, 2 | 150 V | 0.5 amps | 2 minutes | 90 F. | 1.0 |
| Comp. 5 | 1, 2 | 200 V | 4 amps | 10 seconds | 95 F. | 1.1 |
| Comp. 6 | 1, 2 | 100 V | 0.5 amps | 2 minutes | 90 F. | 1.0 |

High Temperature Fire Exposure Testing: A Goss KP-320 Torch with push button ignition, 2.75 inch diameter, and capable of a maximum 500,000 BTU was hosed to a Goss EP-70G High Pressure propane regulator and then to a model 300 Blue Rhino propane tank. In-between the regulator and the torch, a shut-off lever was installed to quickly cut fuel to the torch. Test panels were placed with one of the 4″ sides at 11″ from the torch igniter. The 4″ side was oriented perpendicular, in the z-axis, to the line of sight of the torch and the 6″ side was in line with the torch line of sight. The torch was centered relative to the 4″ side of the test panel. The test panels were held in place with commercially available Simond FireBricks. Test panels were exposed to an open flame from the torch with the propane regulated at 5 PSI for 10 seconds. After the test panels were exposed, the panels were allowed to cool and then were lightly scraped with a scalpel to remove loose coating. The amount of coating completely lost and exposing bare panel from the panel as measured from the edge nearest the flame for each sample is reported in Table 13 below. This test is referred to herein as the FIRE EXPOSURE TEST METHOD. Fire-retardant coatings retain more coating when exposed to flame and have a shorter distance from the edge.

TABLE 13

| | | Category 1 |
|---|---|---|
| | | Distance from |
| Composition | Panel ID | Edge (mm) |
| Comp. 5 | 1 | 7 |
| | 2 | 5 |
| Comp. 6 | 1 | 3 |
| | 2 | 2 |
| Comp. 4 | 1 | 6 |
| | 2 | 4 |
| Comp. 3 | 1 | 32 |
| | 2 | 33 |

The results in Table 13 demonstrate that by including fire resistant, flame-retardant, or high-temperature resistant components into the electrocoat composition, a significant reduction in coating degradation can be achieved when exposed to high temperature environments.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
an electrodepositable binder, and
a thermally conductive, electrically insulative filler material.

2. The electrodepositable coating composition of claim 1, wherein the thermally conductive, electrically insulative filler material is present in an amount of 1% to 39% by volume, based on the total volume of the solids of the electrodepositable coating composition.

3. The electrodepositable coating composition of claim 1, wherein the electrodepositable coating composition is a cationic electrodepositable coating composition and the electrodepositable binder is a cationic electrodepositable binder comprising a cationic salt group-containing, film-forming polymer, and the cationic electrodepositable coating composition is formed by a method comprising the steps of (1) heating an unneutralized cationic salt forming group-containing, film-forming polymer to an elevated temperature; (2) adding the dispersing agent to the unneutralized cationic salt forming group-containing, film-forming polymer with agitation to form a mixture; (3) adding the thermally conductive, electrically insulative filler material to the mixture at elevated temperature with agitation; and (4) dispersing the mixture of the cationic salt forming group-containing, film-forming polymer, the thermally conductive, electrically insulative filler material, and the dispersing agent into an aqueous medium comprising water and a resin neutralizing acid with agitation, wherein the cationic salt forming groups of the cationic salt forming group-containing, film-forming polymer are at least partially neutralized by the resin neutralizing acid to form the cationic salt group-containing film forming polymer.

4-5. (canceled)

6. The electrodepositable coating composition of claim 3, wherein the dispersing agent comprises a dispersing acid.

7. (canceled)

8. The electrodepositable coating composition of claim 6, wherein the dispersing acid comprises an oxyacid of phosphorus, a carboxylic acid, and/or an oxyacid of sulfur.

9. (canceled)

10. The electrodepositable coating composition of claim 6, wherein the dispersing acid comprises phosphoric acid.

11-17. (canceled)

18. The electrodepositable coating composition of claim 1, wherein the electrodepositable coating composition further comprises an aqueous medium comprising water and optionally one or more organic solvents.

19. (canceled)

20. The electrodepositable coating composition of claim 1, wherein the thermally conductive, electrically insulative filler material comprises boron nitride, silicon nitride, aluminum nitride, boron arsenide, aluminum oxide, magnesium oxide, dead burn magnesium oxide, beryllium oxide, silicon dioxide, titanium oxide, zinc oxide, nickel oxide, copper oxide, tin oxide, aluminum hydroxide, magnesium hydroxide, boron arsenide, silicon carbide, agate, emery, ceramic microspheres, and/or diamond.

21. The electrodepositable coating composition of claim 1, wherein the thermally conductive, electrically insulative filler material has a thermal conductivity of 5 W/m·K to 3,000 W/m·K at 25° C., as measured according to ASTM D7984, and
wherein the thermally conductive, electrically insulative filler material have a volume resistivity of at least 10 Ω·m, as measured according to ASTM D257, C611, or B193.

22-27. (canceled)

28. The electrodepositable coating composition of claim 1, wherein the electrodepositable binder further comprises a fire-retardant pigment.

29. An electrodepositable coating composition comprising:
an electrodepositable binder, and
a fire-retardant pigment.

30. The electrodepositable coating composition of claim 1, wherein the electrodepositable coating composition has a resin solids content of less than 30% by weight, based on the total weight of the electrodepositable coating composition, and a viscosity of greater than 2 cP at a shear rate of 0.1/s as measured by the BATH VISCOSITY TEST METHOD or
wherein the electrodepositable coating composition has a resin solids content of less than 30% by weight, based on the total weight of the electrodepositable coating composition, and a viscosity of less than 15 cP at a shear rate of 1,000/s as measured by the BATH VISCOSITY TEST METHOD.

31-32. (canceled)

33. A coating comprising:
an at least partially cured electrodepositable binder and
a thermally conductive, electrically insulative filler material, a fire-retardant pigment, or a combination thereof.

34. (canceled)

35. The coating of claim 33, wherein the coating has a dielectric strength of at least 2 kV at a dry film thickness of 25 microns or less.

36. The coating of claim 33, wherein the coating has a thermal conductivity of at least 0.3 W/m·K, as measured according to ASTM D5470.

37. A coated substrate comprising the coating of claim 33 on at least a portion of a surface of the substrate.

38. The coated substrate of claim 37, wherein the substrate comprises a battery component.

39-40. (canceled)

41. A method of coating a substrate comprising electrodepositing a coating deposited from the electrodepositable coating composition of claim 1 to at least a portion of the substrate.

42-45. (canceled)

46. A substrate comprising an electrodeposited coating layer deposited from the electrodepositable coating composition of claim 29, wherein the electrodeposited coating layer comprises an electrodepositable binder and a fire-retardant pigment, wherein the electrodeposited coating layer has less than 30 mm of coating loss as measured according to the FIRE EXPOSURE TEST METHOD.

47-49. (canceled)

50. The electrodepositable coating composition of claim 1, wherein the electrodepositable coating composition is a cationic electrodepositable coating composition and the electrodepositable binder is a cationic electrodepositable binder comprising a cationic salt group-containing, film-forming polymer.
